(19) United States
(12) Patent Application Publication
(10) Pub. No.: US 2026/0319062 A1
(43) Pub. Date: Oct. 15, 2026

(54) DISTRIBUTED ACOUSTIC WILDLIFE DETECTION AND LOCALIZATION SYSTEM

(71) Applicant: Thomas Victor Hutto, Jackson, AL (US)

(72) Inventor: Thomas Victor Hutto, Jackson, AL (US)

(21) Appl. No.: 19/648,729

(22) Filed: Apr. 15, 2026

Related U.S. Application Data
(60) Provisional application No. 63/834,712, filed on Apr. 15, 2025.

(51) Int. Cl. G01S 5/20; G10L 25/51; H04R 1/08

(52) U.S. Cl. CPC G01S 5/20; H04R 1/08; G10L 25/51

(57) ABSTRACT

A wildlife detection and localization system comprising a plurality of field units positioned across a geographic area, wherein each field unit comprises a microphone array with microphones arranged in a known geometry, a processor configured to determine an estimated bearing to a sound source, a positioning component configured to determine the field unit's geographic position, and a wireless communication interface for transmitting detection data. The system further comprises a server connected to the field units and a non-transitory computer-readable medium containing instructions causing the processor to perform operations comprising receiving detection data including estimated bearings and timestamps, correlating detections from at least two field units corresponding to a same sound event, triangulating a geographic position of the sound source, and generating movement information based on triangulated positions over time.

### CROSS-REFERENCE TO RELATED APPLICATIONS

This application claims priority to a provisional patent application, U.S. Application No. 63/834,712, filed Apr. 4, 2025, which is hereby incorporated by reference in its entirety.

### FIELD OF INVENTION

The present disclosure relates to wildlife detection and monitoring systems, and more particularly to distributed acoustic sensing for wildlife localization, triangulation, and movement tracking.

### BACKGROUND

Wildlife detection and monitoring have long relied on visual observation methods that require direct line-of-sight between the observer and the target animal. Trail cameras, thermal imaging devices, and direct human observation represent common approaches used by hunters, researchers, and land managers to locate and track wildlife across various terrains. These visual methods depend on animals entering a defined field of view, crossing a sensor path, or remaining visible through vegetation, terrain features, and varying light conditions. When animals move behind cover, into dense timber, over ridgelines, or through tall grass, visual detection methods typically fail to provide useful location information. The effectiveness of camera-based systems is further limited by their fixed placement, narrow detection angles, and inability to monitor large areas without deploying numerous individual units. Human observers face additional constraints including fatigue, limited attention span, inability to maintain continuous coverage, and difficulty operating effectively during darkness or inclement weather.

Acoustic detection represents an alternative approach to wildlife monitoring that does not depend on visual line-of-sight between the sensor and the animal. Many wildlife species produce vocalizations, movement sounds, or other acoustic signatures that can be detected at distances beyond visual range and through obstructions that would block optical sensors. Single-microphone recording devices have been used to capture wildlife sounds for later analysis, species identification, and presence confirmation in various habitats. However, these single-point acoustic devices generally capture sound without determining the direction from which the sound originated, providing no spatial information beyond confirming that an animal vocalized somewhere within the microphone's detection range. Human listeners can estimate bearing to a sound source with some degree of accuracy, but such estimates are subjective, difficult to replicate, and cannot be systematically recorded or compared across multiple observation sessions. The lack of directional information from conventional acoustic recording devices limits their utility for applications requiring knowledge of animal position, movement direction, or travel patterns.

Determining the geographic position of a vocalizing animal from acoustic detections presents challenges that existing wildlife monitoring tools do not adequately address. Triangulation methods that combine directional estimates from multiple observation points can theoretically locate a sound source, but implementing such methods in field conditions requires coordinated sensors with known positions, synchronized timing, and processing capabilities that standalone recording devices do not provide. Existing electronic game callers can emit wildlife sounds to attract animals but do not incorporate listening, localization, or response analysis functions that would allow understanding of animal movement in relation to the emitted sounds. Trail cameras and acoustic recorders typically produce isolated, point-in-time detections that do not support reconstruction of travel direction, speed, or repeated path usage over time. Wildlife researchers and hunters often seek to understand not just where an animal was detected at a single moment, but where the animal came from, where it is heading, and whether it uses particular routes or locations repeatedly across days, weeks, or seasons.

The integration of detection data across multiple sensors, time periods, and geographic areas remains difficult with conventional wildlife monitoring equipment. Most existing devices store data locally on removable media, requiring physical retrieval before information can be reviewed or analyzed. Comparing detections from different devices, correlating events that may represent the same animal, and building historical records of movement patterns typically require manual effort that limits practical application in field settings. Visualization of wildlife activity in geographic context, such as overlaying detections on maps showing terrain, vegetation, water features, and property boundaries, is generally not supported by standalone recording or camera devices. The ability to distinguish between different individual animals of the same species based on acoustic characteristics, which could support tracking of specific animals over time, is not a feature commonly available in existing wildlife monitoring products. These limitations in data integration, spatial analysis, and individual recognition constrain the utility of current approaches for applications requiring detailed understanding of wildlife location, movement, and behavior patterns.

Accordingly, there is a need in the art for a distributed acoustic system capable of detecting, localizing, and tracking wildlife movement across large areas.

### SUMMARY

A system and method for distributed acoustic wildlife detection and localization is provided. In one aspect, the present invention is a system of field units positioned at spaced locations across a geographic area that detect and triangulate wildlife vocalizations. In another aspect, the present invention is a system that objectively and automatically determines the geographic position of vocalizing animals based on bearing estimates from multiple field units. In yet another aspect, the present invention is a method for identifying wildlife species and individual animals by analyzing acoustic characteristics of detected vocalizations using machine learning classification models. In still another aspect, the present invention is a method for aggregating triangulated position data to identify recurring travel routes and generate predictive models for wildlife movement. Generally, the present invention enables remote monitoring of wildlife across large areas through coordinated acoustic sensing and triangulation.

According to an aspect of the present disclosure, a wildlife detection and localization system is provided. The system comprises a plurality of field units positioned at spaced locations across a geographic area, wherein each field unit of the plurality of field units comprises a microphone array having a plurality of microphones arranged in a known geometry. Each field unit further comprises a processor configured to determine an estimated bearing to a sound source based on signals received by the plurality of microphones. Each field unit additionally comprises a positioning component configured to determine a geographic position of the field unit and a wireless communication interface configured to transmit detection data. The system further comprises a server operably connected to the plurality of field units via the wireless communication modules and a non-transitory computer-readable medium coupled to the processor. The non-transitory computer-readable medium contains instructions stored thereon, which, when executed by the processor, cause the processor to perform operations comprising receiving detection data from the plurality of field units, wherein the detection data includes estimated bearings and timestamps, correlating detections from at least two field units that correspond to a same sound event, triangulating a geographic position of the sound source based on the estimated bearings from the at least two field units and the geographic positions of the at least two field units, and generating movement information based on a plurality of triangulated positions over time.

According to other aspects of the present disclosure, the wildlife detection and localization system may include one or more of the following features. In a preferred embodiment, the processor may be configured to determine the estimated bearing based on at least one of time difference of arrival, phase difference, amplitude difference, or beamforming. In some preferred embodiments, each field unit may further comprise a synchronized clock configured to timestamp detections, wherein the timestamps enable the central server to match detections from the plurality of field units. In another preferred embodiment, the central server may be further configured to classify a species of an animal producing the sound source based on acoustic characteristics of the sound source using a machine learning classification model trained on wildlife vocalizations. In some instances, the central server may be further configured to generate an acoustic signature associated with an individual animal using a machine learning feature extraction model based on at least one of frequency content, cadence, harmonic structure, temporal spacing, call length, or amplitude envelope. The central server may alternatively be further configured to compare a subsequent detection with the acoustic signature using a machine learning similarity model to determine whether the subsequent detection corresponds to the individual animal.

In some preferred embodiments, the central server may be further configured to identify recurring travel routes based on aggregated triangulated positions over a plurality of time periods using a machine learning pattern recognition model. The central server may optionally be further configured to generate at least one of a heat map, a line overlay, or a probability zone representing the recurring travel routes on a geospatial map. In a preferred embodiment, the processor of each field unit may be further configured to perform local filtering using a machine learning noise reduction model to reduce at least one of wind noise, rain noise, insect noise, vehicle noise, or background interference before transmitting the detection data. In another preferred embodiment, at least one field unit may further comprise a sound emitter configured to produce sounds into an environment, wherein the sounds include at least one of wildlife vocalizations, calibration signals, or test tones. The sound emitter may alternatively be controllable remotely through a user interface operably connected to the central server.

According to another aspect of the present disclosure, a method for detecting and localizing wildlife using distributed acoustic sensing is provided. The method comprises a step of receiving, by a plurality of field units positioned at spaced locations across a geographic area, acoustic signals from a sound source, wherein each field unit comprises a microphone array having a plurality of microphones arranged in a known geometry. The method further comprises a step of determining, by a processor of each field unit, an estimated bearing to the sound source based on the acoustic signals received by the plurality of microphones. The method additionally comprises a step of transmitting, by each field unit, detection data including the estimated bearing and a timestamp to a central server. The method also comprises a step of correlating, by the central server, detections from at least two field units that correspond to a same sound event. The method further comprises a step of triangulating, by the central server, a geographic position of the sound source based on the estimated bearings from the at least two field units and geographic positions of the at least two field units, a step of classifying, by the central server using a machine learning classification model, the sound source as a target wildlife species, and a step of inferring, by the central server, a travel path based on a plurality of triangulated positions of the sound source over time.

According to other aspects of the present disclosure, the method may include one or more of the following features. In a preferred embodiment, the step of determining the estimated bearing may comprise at least one of time difference of arrival analysis, phase difference analysis, amplitude difference analysis, or beamforming. In some preferred embodiments, the method may further comprise a step of training the machine learning classification model on a dataset of wildlife vocalizations comprising a plurality of species-specific acoustic samples. In another preferred embodiment, the method may further comprise steps of generating, by the central server using a machine learning feature extraction model, an acoustic signature associated with an individual animal based on at least one of frequency content, cadence, harmonic structure, temporal spacing, call length, or amplitude envelope, and comparing, using a machine learning similarity model, a subsequent detection with the acoustic signature to determine whether the subsequent detection corresponds to the individual animal. In some instances, the method may further comprise a step of generating, by the central server using a machine learning pattern recognition model, at least one of a heat map, a line overlay, or a probability zone representing recurring travel routes on a geospatial map based on aggregated triangulated positions over a plurality of time periods.

According to another aspect of the present disclosure, a non-transitory computer-readable medium containing instructions for wildlife detection and localization is provided. The non-transitory computer-readable medium is coupled to a processor, wherein the non-transitory computer-readable medium contains instructions stored thereon, which, when executed by the processor, cause the processor to perform operations comprising receiving detection data from a plurality of field units positioned at spaced locations across a geographic area, wherein each field unit comprises a microphone array configured to determine an estimated bearing to a sound source, and wherein the detection data includes the estimated bearing, a timestamp, and a geographic position of each field unit. The operations further comprise correlating detections from at least two field units that correspond to a same sound event based on the timestamps. The operations additionally comprise triangulating a geographic position of the sound source based on the estimated bearings from the at least two field units and the geographic positions of the at least two field units. The operations also comprise classifying the sound source as a target wildlife species using a machine learning classification model trained on a dataset of wildlife vocalizations, generating movement information based on a plurality of triangulated positions over time using a machine learning trajectory prediction model, and presenting, via a user interface, a geospatial map displaying the triangulated geographic positions and the movement information.

According to other aspects of the present disclosure, the non-transitory computer-readable medium may include additional instructions causing the processor to perform additional operations. In a preferred embodiment, the additional operations may comprise generating an acoustic signature associated with an individual animal using a machine learning feature extraction model based on at least one of frequency content, cadence, harmonic structure, temporal spacing, call length, or amplitude envelope, and comparing a subsequent detection with the acoustic signature using a machine learning similarity model to determine whether the subsequent detection corresponds to the individual animal. In some preferred embodiments, the additional operations may comprise maintaining separate tracks for different animals based on the acoustic signatures when multiple animals are detected within the geographic area using a machine learning multi-target tracking model. In another preferred embodiment, the additional operations may comprise generating at least one of a heat map, a line overlay, or a probability zone representing recurring travel routes on the geospatial map based on aggregated triangulated positions over a plurality of time periods using a machine learning pattern recognition model.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates an exemplary environment of a system comprising clients connected to a server and a database via a network, according to aspects of the present disclosure.

FIG. 2 illustrates a block diagram of a computing entity, according to aspects of the present disclosure.

FIG. 3 illustrates exemplary computing entities in the form of a computing device and a mobile computing device, according to aspects of the present disclosure.

FIG. 4 illustrates a block diagram of a system for distributed acoustic wildlife detection and localization, according to aspects of the present disclosure.

FIG. 5 illustrates an exploded view of a field unit for distributed acoustic wildlife detection, according to aspects of the present disclosure.

FIG. 6 illustrates multiple views of the field unit of FIG. 5 configured for outdoor wildlife acoustic detection, according to an embodiment.

FIG. 7 illustrates a flowchart of a method for wildlife detection and localization, according to aspects of the present disclosure.

FIG. 8 illustrates a flowchart of a method for identifying wildlife travel paths, according to aspects of the present disclosure.

FIG. 9 illustrates a block diagram of a security method depicting permission levels for accessing user content within a database, according to aspects of the present disclosure.

### DETAILED DESCRIPTION

The following description sets forth exemplary aspects of the present disclosure. It should be recognized, however, that such description is not intended as a limitation on the scope of the present disclosure

In the Summary above and in this Detailed Description, and the claims below, and in the accompanying drawings, reference is made to particular features, including method steps, of the invention. It is to be understood that the disclosure of the invention in this specification includes all possible combinations of such particular features. For instance, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises”, and grammatical equivalents thereof are used herein to mean that other components, steps, etc. are optionally present. For instance, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). As will be evident from the disclosure provided below, the present invention satisfies the need for a system and method capable of monitoring and managing the health of its users.

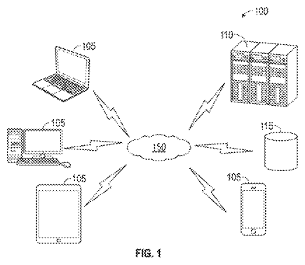

FIG. 1 depicts an exemplary environment 100 of the system 400 consisting of clients 105 connected to a server 110 and/or database 115 via a network 150. Clients 105 are devices of users 405 that may be used to access servers 110 and/or databases 115 through a network 150. A network 150 may comprise of one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks. In a preferred embodiment, computing entities 200 may act as clients 105 for a user 405. For instance, a client 105 may include a personal computer, a wireless telephone, a streaming device, a “smart” television, a personal digital assistant (PDA), a laptop, a smart phone, a tablet computer, or another type of computation or communication interface 280. Servers 110 may include devices that access, fetch, aggregate, process, search, provide, and/or maintain documents. Although FIG. 1 depicts a preferred embodiment of an environment 100 for the system 400, in other implementations, the environment 100 may contain fewer components, different components, differently arranged components, and/or additional components than those depicted in FIG. 1. Alternatively, or additionally, one or more components of the environment 100 may perform one or more other tasks described as being performed by one or more other components of the environment 100.

As depicted in FIG. 1, one embodiment of the system 400 may comprise a server 110. Although shown as a single server 110 in FIG. 1, a server 110 may, in some implementations, be implemented as multiple devices interlinked together via the network 150, wherein the devices may be distributed over a large geographic area and performing different functions or similar functions. For instance, two or more servers 110 may be implemented to work as a single server 110 performing the same tasks. Alternatively, one server 110 may perform the functions of multiple servers 110. For instance, a single server 110 may perform the tasks of a web server and an indexing server 110. Additionally, it is understood that multiple servers 110 may be used to operably connect the processor 220 to the database 115 and/or other content repositories. The processor 220 may be operably connected to the server 110 via wired or wireless connection. Types of servers 110 that may be used by the system 400 include, but are not limited to, search servers, document indexing servers, and web servers, or any combination thereof.

Search servers may include one or more computing entities 200 designed to implement a search engine, such as a documents/records search engine, general webpage search engine, etc. Search servers may, for instance, include one or more web servers designed to receive search queries and/or inputs from users 405, search one or more databases 115 in response to the search queries and/or inputs, and provide documents or information, relevant to the search queries and/or inputs, to users 405. In some implementations, search servers may include a web search server that may provide webpages to users 405, wherein a provided webpage may include a reference to a web server at which the desired information and/or links are located. The references to the web server at which the desired information is located may be included in a frame and/or text box, or as a link to the desired information/document. Document indexing servers may include one or more devices designed to index documents available through networks 150. Document indexing servers may access other servers 110, such as web servers that host content, to index the content. In some implementations, document indexing servers may index documents/records stored by other servers 110 connected to the network 150. Document indexing servers may, for instance, store and index content, information, and documents relating to user accounts and user-generated content. Web servers may include servers 110 that provide webpages to clients 105. For instance, the webpages may be HTML-based webpages. A web server may host one or more websites. As used herein, a website may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

As used herein, a database 115 refers to a set of related data and the way it is organized. Access to this data is usually provided by a database management system (DBMS) consisting of an integrated set of computer software that allows users 405 to interact with one or more databases 115 and provides access to all of the data contained in the database 115. The DBMS provides various functions that allow entry, storage and retrieval of large quantities of information and provides ways to manage how that information is organized. Because of the close relationship between the database 115 and the DBMS, as used herein, the term database 115 refers to both a database 115 and DBMS.

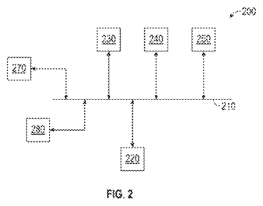

FIG. 2 is an exemplary diagram of a client 105, server 110, and/or or database 115 (hereinafter collectively referred to as “computing entity 200”), which may correspond to one or more of the clients 105, servers 110, and databases 115 according to an implementation consistent with the principles of the invention as described herein. The computing entity 200 may comprise a bus 210, a processor 220, memory 304, a storage device 250, a peripheral device 270, and a communication interface 280 (such as wired or wireless communication device). The bus 210 may be defined as one or more conductors that permit communication among the components of the computing entity 200. The processor 220 may be defined as logic circuitry that responds to and processes the basic instructions that drive the computing entity 200. Memory 304 may be defined as the integrated circuitry that stores information for immediate use in a computing entity 200. A peripheral device 270 may be defined as any hardware used by a user 405 and/or the computing entity 200 to facilitate communicate between the two. A storage device 250 may be defined as a device used to provide mass storage to a computing entity 200. A communication interface 280 may be defined as any transceiver-like device that enables the computing entity 200 to communicate with other devices and/or computing entities 200.

The bus 210 may comprise a high-speed interface 308 and/or a low-speed interface 312 that connects the various components together in a way such they may communicate with one another. A high-speed interface 308 manages bandwidth-intensive operations for computing device 300, while a low-speed interface 312 manages lower bandwidth-intensive operations. In some preferred embodiments, the high-speed interface 308 of a bus 210 may be coupled to the memory 304, display 316, and to high-speed expansion ports 310, which may accept various expansion cards such as a graphics processing unit (GPU). In other preferred embodiments, the low-speed interface 312 of a bus 210 may be coupled to a storage device 250 and low-speed expansion ports 314. The low-speed expansion ports 314 may include various communication ports, such as USB, Bluetooth, Ethernet, wireless Ethernet, etc. Additionally, the low-speed expansion ports 314 may be coupled to one or more peripheral devices 270, such as a keyboard, pointing device, scanner, and/or a networking device, wherein the low-speed expansion ports 314 facilitate the transfer of input data from the peripheral devices 270 to the processor 220 via the low-speed interface 312.

The processor 220 may comprise any type of conventional processor or microprocessor that interprets and executes computer readable instructions. The processor 220 is configured to perform the operations disclosed herein based on instructions stored within the system 400. The processor 220 may process instructions for execution within the computing entity 200, including instructions stored in memory 304 or on a storage device 250, to display graphical information for a graphical user interface (GUI) on an external peripheral device 270, such as a display 316. The processor 220 may provide for coordination of the other components of a computing entity 200, such as control of user interfaces 411, 511, 711, applications run by a computing entity 200, and wireless communication by a communication interface 280 of the computing entity 200. The processor 220 may be any processor or microprocessor suitable for executing instructions. In some embodiments, the processor 220 may have a memory device therein or coupled thereto suitable for storing the data, content, or other information or material disclosed herein. In some instances, the processor 220 may be a component of a larger computing entity 200. A computing entity 200 that may house the processor 220 therein may include, but are not limited to, laptops, desktops, workstations, personal digital assistants, servers 110, mainframes, cellular telephones, tablet computers, smart televisions, streaming devices, or any other similar device. Accordingly, the inventive subject matter disclosed herein, in full or in part, may be implemented or utilized in devices including, but are not limited to, laptops, desktops, workstations, personal digital assistants, servers 110, mainframes, cellular telephones, tablet computers, smart televisions, streaming devices, or any other similar device.

Memory 304 stores information within the computing device 300. In some preferred embodiments, memory 304 may include one or more volatile memory units. In another preferred embodiment, memory 304 may include one or more non-volatile memory units. Memory 304 may also include another form of computer-readable medium, such as a magnetic, solid state, or optical disk. For instance, a portion of a magnetic hard drive may be partitioned as a dynamic scratch space to allow for temporary storage of information that may be used by the processor 220 when faster types of memory, such as random-access memory (RAM), are in high demand. A computer-readable medium may refer to a non-transitory computer-readable memory device. A memory device may refer to storage space within a single storage device 250 or spread across multiple storage devices 250. The memory 304 may comprise main memory 230 and/or read only memory (ROM) 240. In a preferred embodiment, the main memory 230 may comprise RAM or another type of dynamic storage device 250 that stores information and instructions for execution by the processor 220. ROM 240 may comprise a conventional ROM device or another type of static storage device 250 that stores static information and instructions for use by processor 220. The storage device 250 may comprise a magnetic and/or optical recording medium and its corresponding drive.

As mentioned earlier, a peripheral device 270 is a device that facilitates communication between a user 405 and the processor 220. The peripheral device 270 may include, but is not limited to, an input device and/or an output device. As used herein, an input device may be defined as a device that allows a user 405 to input data and instructions that is then converted into a pattern of electrical signals in binary code that are comprehensible to a computing entity 200. An input device of the peripheral device 270 may include one or more conventional devices that permit a user 405 to input information into the computing entity 200, such as a controller, scanner, phone, camera, scanning device, keyboard, a mouse, a pen, voice recognition and/or biometric mechanisms, etc. As used herein, an output device may be defined as a device that translates the electronic signals received from a computing entity 200 into a form intelligible to the user 405. An output device of the peripheral device 270 may include one or more conventional devices that output information to a user 405, including a display 316, a printer, a speaker, an alarm, a projector, etc. Additionally, storage devices 250, such as CD-ROM drives, and other computing entities 200 may act as a peripheral device 270 that may act independently from the operably connected computing entity 200. For instance, a streaming device may transfer data to a smartphone, wherein the smartphone may use that data in a manner separate from the streaming device.

The storage device 250 is capable of providing the computing entity 200 mass storage. In some embodiments, the storage device 250 may comprise a computer-readable medium such as the memory 304, storage device 250, or memory 304 on the processor 220. A computer-readable medium may be defined as one or more physical or logical memory devices and/or carrier waves. Devices that may act as a computer readable medium include, but are not limited to, a hard disk device, optical disk device, tape device, flash memory or other similar solid-state memory device, or an array of devices, including devices in a storage area network or other configurations. Examples of computer-readable mediums include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as ROM 240, RAM, flash memory, and the like.

In an embodiment, a computer program may be tangibly embodied in the storage device 250. The computer program may contain instructions that, when executed by the processor 220, performs one or more steps that comprise a method, such as those methods described herein. The instructions within a computer program may be carried to the processor 220 via the bus 210. Alternatively, the computer program may be carried to a computer-readable medium, wherein the information may then be accessed from the computer-readable medium by the processor 220 via the bus 210 as needed. In a preferred embodiment, the software instructions may be read into memory 304 from another computer-readable medium, such as data storage device 250, or from another device via the communication interface 280. Alternatively, hardwired circuitry may be used in place of or in combination with software instructions to implement processes consistent with the principles as described herein. Thus, implementations consistent with the invention as described herein are not limited to any specific combination of hardware circuitry and software.

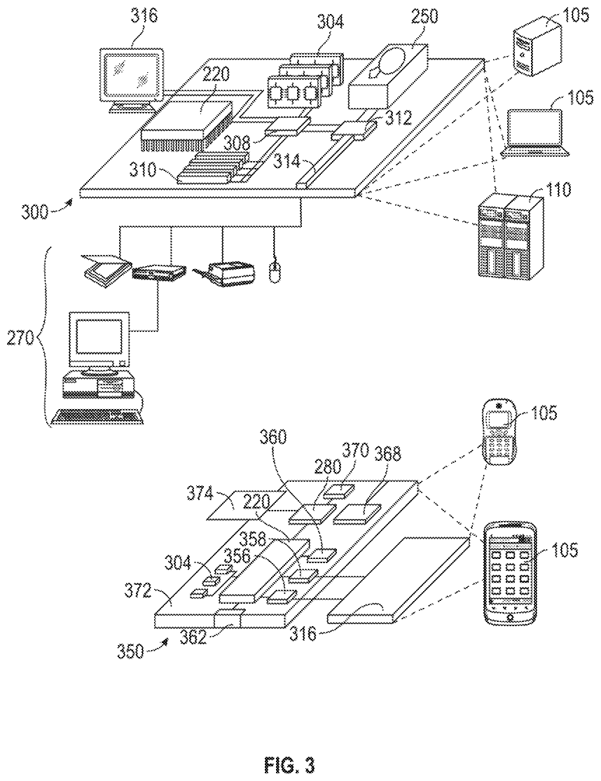

FIG. 3 depicts exemplary computing entities 200 in the form of a computing device 300 and mobile computing device 350, which may be used to carry out the various embodiments of the invention as described herein. A computing device 300 is intended to represent various forms of digital computers, such as laptops, desktops, workstations, servers 110, databases 115, mainframes, and other appropriate computers. A mobile computing device 350 is intended to represent various forms of mobile devices, such as scanners, scanning devices, personal digital assistants, cellular telephones, smart phones, tablet computers, and other similar devices. The various components depicted in FIG. 3, as well as their connections, relationships, and functions are meant to be examples only, and are not meant to limit the implementations of the invention as described herein. The computing device 300 may be implemented in a number of different forms, as shown in FIGS. 1 and 3. For instance, a computing device 300 may be implemented as a server 110 or in a group of servers 110. Computing devices 300 may also be implemented as part of a rack server system. In addition, a computing device 300 may be implemented as a personal computer, such as a desktop computer or laptop computer. Alternatively, components from a computing device 300 may be combined with other components in a mobile device, thus creating a mobile computing device 350. Each mobile computing device 350 may contain one or more computing devices 300 and mobile devices, and an entire system may be made up of multiple computing devices 300 and mobile devices communicating with each other as depicted by the mobile computing device 350 in FIG. 3. The computing entities 200 consistent with the principles of the invention as disclosed herein may perform certain receiving, communicating, generating, output providing, correlating, and storing operations as needed to perform the various methods as described in greater detail below.

In the embodiment depicted in FIG. 3, a computing device 300 may include a processor 220, memory 304 a storage device 250, high-speed expansion ports 310, low-speed expansion ports 314, and bus 210 operably connecting the processor 220, memory 304, storage device 250, high-speed expansion ports 310, and low-speed expansion ports 314. In one preferred embodiment, the bus 210 may comprise a high-speed interface 308 connecting the processor 220 to the memory 304 and high-speed expansion ports 310 as well as a low-speed interface 312 connecting to the low-speed expansion ports 314 and the storage device 250. Because each of the components are interconnected using the bus 210, they may be mounted on a common motherboard as depicted in FIG. 3 or in other manners as appropriate. The processor 220 may process instructions for execution within the computing device 300, including instructions stored in memory 304 or on the storage device 250. Processing these instructions may cause the computing device 300 to display graphical information for a GUI on an output device, such as a display 316 coupled to the high-speed interface 308. In other implementations, multiple processors and/or multiple buses may be used, as appropriate, along with multiple memory units and/or multiple types of memory. Additionally, multiple computing devices may be connected, wherein each device provides portions of the necessary operations.

A mobile computing device 350 may include a processor 220, memory 304 a peripheral device 270 (such as a display 316, a communication interface 280, and a transceiver 368, among other components). A mobile computing device 350 may also be provided with a storage device 250, such as a micro-drive or other previously mentioned storage device 250, to provide additional storage. Preferably, each of the components of the mobile computing device 350 are interconnected using a bus 210, which may allow several of the components of the mobile computing device 350 to be mounted on a common motherboard as depicted in FIG. 3 or in other manners as appropriate. In some implementations, a computer program may be tangibly embodied in an information carrier. The computer program may contain instructions that, when executed by the processor 220, perform one or more methods, such as those described herein. The information carrier is preferably a computer-readable medium, such as memory, expansion memory 374, or memory 304 on the processor 220 such as ROM 240, that may be received via the transceiver or external interface 362. The mobile computing device 350 may be implemented in a number of different forms, as shown in FIG. 3. For instance, a mobile computing device 350 may be implemented as a cellular telephone, part of a smart phone, personal digital assistant, or other similar mobile device.

The processor 220 may execute instructions within the mobile computing device 350, including instructions stored in the memory 304 and/or storage device 250. The processor 220 may be implemented as a chipset of chips that may include separate and multiple analog and/or digital processors. The processor 220 may provide for coordination of the other components of the mobile computing device 350, such as control of the user interfaces 411, 511, 711, applications run by the mobile computing device 350, and wireless communication by the mobile computing device 350. The processor 220 of the mobile computing device 350 may communicate with a user 405 through the control interface 358 coupled to a peripheral device 270 and the display interface 356 coupled to a display 316. The display 316 of the mobile computing device 350 may include, but is not limited to, Liquid Crystal Display (LCD), Light Emitting Diode (LED) display, Organic Light Emitting Diode (OLED) display, and Plasma Display Panel (PDP), holographic displays, augmented reality displays, virtual reality displays, or any combination thereof. The display interface 356 may include appropriate circuitry for causing the display 316 to present graphical and other information to a user 405. The control interface 358 may receive commands from a user 405 via a peripheral device 270 and convert the commands into a computer readable signal for the processor 220. In addition, an external interface 362 may be provided in communication with processor 220, which may enable near area communication of the mobile computing device 350 with other devices. The external interface 362 may provide for wired communications in some implementations or wireless communication in other implementations. In a preferred embodiment, multiple interfaces may be used in a single mobile computing device 350 as is depicted in FIG. 3.

Memory 304 stores information within the mobile computing device 350. Devices that may act as memory 304 for the mobile computing device 350 include, but are not limited to computer-readable media, volatile memory, and non-volatile memory. Expansion memory 374 may also be provided and connected to the mobile computing device 350 through an expansion interface 372, which may include a Single In-Line Memory Module (SIM) card interface or micro secure digital (Micro-SD) card interface. Expansion memory 374 may include, but is not limited to, various types of flash memory and non-volatile random-access memory (NVRAM). Such expansion memory 374 may provide extra storage space for the mobile computing device 350. In addition, expansion memory 374 may store computer programs or other information that may be used by the mobile computing device 350. For instance, expansion memory 374 may have instructions stored thereon that, when carried out by the processor 220, cause the mobile computing device 350 perform the methods described herein. Further, expansion memory 374 may have secure information stored thereon; therefore, expansion memory 374 may be provided as a security module for a mobile computing device 350, wherein the security module may be programmed with instructions that permit secure use of a mobile computing device 350. In addition, expansion memory 374 having secure applications and secure information stored thereon may allow a user 405 to place identifying information on the expansion memory 374 via the mobile computing device 350 in a non-hackable manner.

A mobile computing device 350 may communicate wirelessly through the communication interface 280, which may include digital signal processing circuitry where necessary. The communication interface 280 may provide for communications under various modes or protocols, including, but not limited to, Global System Mobile Communication (GSM), Short Message Services (SMS), Enterprise Messaging System (EMS), Multimedia Messaging Service (MMS), Code Division Multiple Access (CDMA), Time Division Multiple Access (TDMA), Personal Digital Cellular (PDC), Wideband Code Division Multiple Access (WCDMA), IMT Multi-Carrier (CDMAX 0), and General Packet Radio Service (GPRS), or any combination thereof. Such communication may occur, for example, through a transceiver 368. Short-range communication may occur, such as using a Bluetooth, WIFI, or other such transceiver 368. In addition, a Global Positioning System (GPS) receiver module 370 may provide additional navigation-and location-related wireless data to the mobile computing device 350, which may be used as appropriate by applications running on the mobile computing device 350. Alternatively, the mobile computing device 350 may communicate audibly using an audio codec 360, which may receive spoken information from a user 405 and covert the received spoken information into a digital form that may be processed by the processor 220. The audio codec 360 may likewise generate audible sound for a user 405, such as through a speaker, e.g., in a handset of mobile computing device 350. Such sound may include sound from voice telephone calls, recorded sound such as voice messages, music files, etc. Sound may also include sound generated by applications operating on the mobile computing device 350.

The system 400 may comprise a power supply, which may be any source of power that provides the system 400 with the required energy. In a preferred embodiment, the power supply may be a stationary power source that has been installed in a way such that it is fastened in place, such as a 3-prong wall outlet. In a preferred embodiment, the stationary power source is connected to the wiring system of a premises, such as a house or a building. In another preferred embodiment, the power supply may be a mobile power source, such as a battery pack, gas-powered generator, alternator, and fuel cell. In a preferred embodiment, the mobile power source does not need to be connected to the wiring system of a premises to provide power to the system but may be capable of connecting to the wiring system of said premises to provide power to a system connected thereto. In another preferred embodiment, the system 400 may comprise multiple power supplies configured to supply power to the system 400 in different circumstances. For instance, the system 400 may be directly plugged into a stationary power source, which may provide power to the system 400 so long as the system does not move out of range of said stationary power source, as well as connected to a mobile power source, which may provide power to the system 400 when the system 400 is not connected to a stationary power source or in situations where the stationary power source ceases to provide power to the system 400. In yet another preferred embodiment, a plurality of solar charging panels may be operably connected to a battery of the system, which may then supply power to the system either directly or via the wiring of the premises. As such, the system 400 may be configured to receive power in a variety of ways without departing from the inventive subject matter described herein.

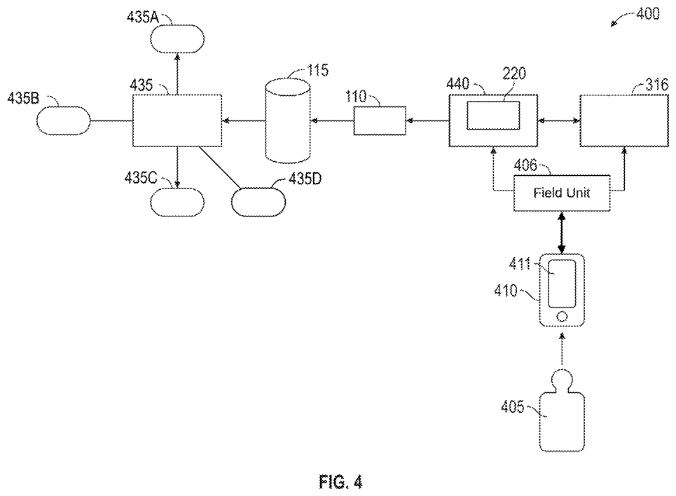

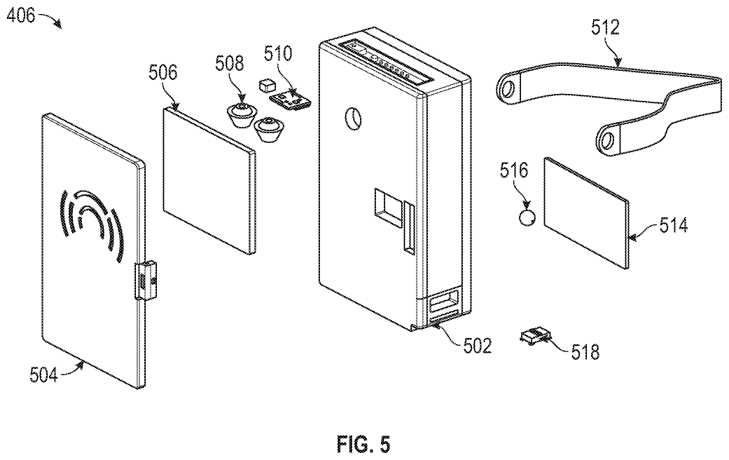

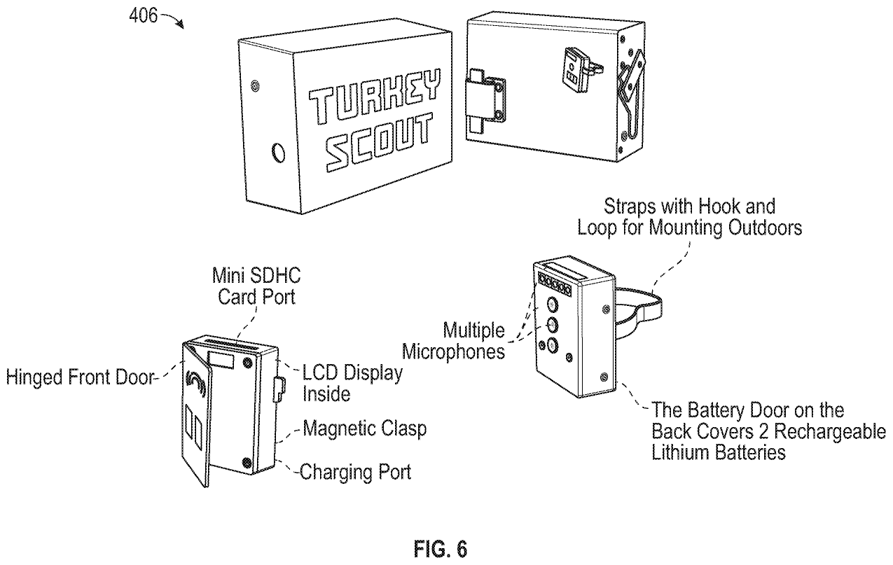

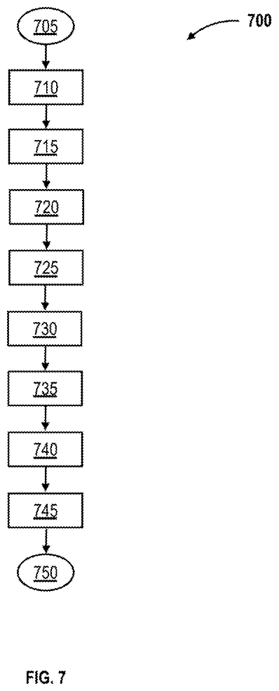

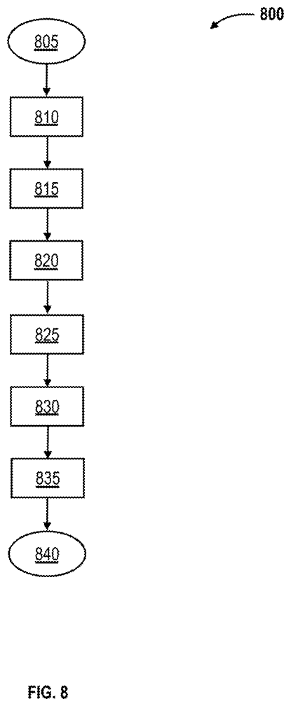

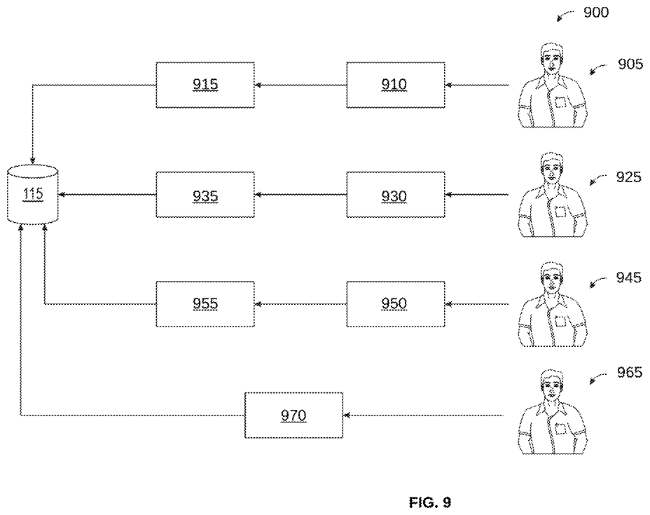

FIGS. 1-9 illustrate embodiments of a system and method for distributed acoustic wildlife detection and localization. FIG. 1 illustrates an environment 100 depicting a network architecture comprising clients 105 connected to a server 110 and a database 115 via a network 150. FIG. 2 illustrates a block diagram of a computing entity 200 comprising a bus 210, a processor 220, main memory 230, ROM 240, a storage device 250, a peripheral device 270, and a communication interface 280. FIG. 3 illustrates a system diagram depicting exemplary computing entities 200 in the form of a computing device 300 and a mobile computing device 350, showing components including processor 220, memory 304, display 316, GPS receiver module 370, transceiver 368, and connections to a server 110 and clients 105. FIG. 4 illustrates a block diagram of a system 400 comprising a server 110, a processor 220, a display 316, a mobile computing device 410 with a user interface 411, a non-transitory computer-readable medium 440, a field unit 406, and a database 115 storing a user profile 435 containing user data 435A, wildlife data 435B, path data 435C, and environmental data 435D, with a user 405 accessing the system. FIG. 5 illustrates an exploded view of a field unit 406 comprising a body 502, a door 504, a screen 506, a microphone 508, a Mini SDHC card port 510, a belt 512, a cover 514, a lock 516, and a USB Type-C port 518. FIG. 6 illustrates multiple views of the field unit 406 configured for outdoor wildlife acoustic detection, showing the assembled housing and annotated detail views highlighting key features including microphones, LCD display, mounting straps, and battery compartment. FIG. 7 illustrates a flow diagram detailing a method 700 for wildlife detection and localization comprising steps 705-750 for initializing field units, continuous acoustic monitoring, analyzing acoustic signals, bearing estimation, transmitting detection data, correlating detections, triangulating geographic positions, generating movement information, and presenting results via a geographic information system. FIG. 8 illustrates a flow diagram detailing a method 800 for identifying wildlife travel paths comprising steps 805-840 for aggregating triangulated position data, spatial clustering analysis, reconstructing individual travel paths, species-specific path preference analysis, generating predictive models, presenting identified paths, and updating the path database. FIG. 9 illustrates the manner in which individual access to data may be granted or limited based on permission levels 900, user roles 910, 930, 950, and administrator roles 970, showing requesting users 905, 925, 945 accessing user content 915, 935, 955 stored in a database 115. It is understood that the methods disclosed herein may be carried out by the system illustrated in FIGS. 1-6.

As illustrated in FIG. 4, the present disclosure describes a system 400 for distributed acoustic wildlife detection and localization that may be configured to detect, classify, and track wildlife based on acoustic signals captured across a geographic area. In a preferred embodiment, the system 400 comprises a plurality of field units 406 positioned at spaced locations across the geographic area, wherein each field unit 406 of the plurality of field units 406 may be configured to capture acoustic signals from wildlife and determine directional information associated with detected sounds. The system 400 further comprises a server 110 operably connected to the plurality of field units 406 via wireless communication interfaces, wherein the server 110 may receive detection data from the field units 406 and perform triangulation, classification, and movement analysis operations. In some preferred embodiments, the system 400 may be used for turkey, deer, elk, moose, feral hogs, bear, coyote, wolves, ducks, and other wildlife that produce identifiable sounds. Alternatively, the system 400 may be configured for non-hunting uses such as wildlife research, conservation, depredation control, and habitat monitoring. The system 400 provides a user 405 with location, movement, and pattern information based on acoustic detection rather than relying on visual detection methods.

With continued reference to FIG. 4, each field unit 406 comprises a positioning component configured to determine a geographic position of the field unit 406, which may include a GPS receiver module 370 or other location-determining technology. The positioning component allows the system 400 to associate each detection with a known geographic reference point, which enables triangulation when multiple field units 406 detect the same sound event. In a preferred embodiment, each field unit 406 further comprises a wireless communication interface configured to transmit detection data to the server 110, wherein the wireless communication interface may utilize cellular, Wi-Fi, satellite, mesh radio, LoRa, or other wired or wireless communication paths depending on the installation environment. The field unit 406 may include a housing suitable for outdoor use to protect internal components from environmental conditions such as rain, humidity, temperature extremes, and dust. In some instances, the field unit 406 may include a solar charging system as a power source in addition to or instead of a battery, which can extend operational duration in remote locations without access to electrical infrastructure. The field units 406 may be fixed in place at permanent locations, or alternatively, the field units 406 may be portable and repositionable by the user 405 based on terrain or seasonal changes.

As further shown in FIG. 4, the system 400 comprises a mobile computing device 410 having a user interface 411 through which the user 405 may interact with the system 400. In a preferred embodiment, the mobile computing device 410 may be configured to display detection data, triangulated wildlife positions, estimated travel paths, and historical movement patterns on a geospatial map presented through the user interface 411. The user interface 411 may allow the user 405 to select a time range, species, individual animal signature, confidence threshold, or property boundary to filter the information shown. In some preferred embodiments, the user interface 411 can provide near real-time alerts indicating that a target wildlife sound has been detected, along with a direction or mapped location. The mobile computing device 410 may communicate with the server 110 via the network 150 to receive processed detection data and analysis results. Alternatively, the mobile computing device 410 may communicate directly with one or more field units 406 in configurations where local connectivity is available.

In another preferred embodiment, the system 400 stores information within a user profile 435 maintained on the database 115, as illustrated in FIG. 4. The user profile 435 contains a plurality of data categories that support the detection, localization, and tracking functions of the system 400. User data 435A stored within the user profile 435 may include account information, preferences, property boundaries, field unit 406 placement configurations, and notification settings associated with the user 405. Wildlife data 435B stored within the user profile 435 may include species classifications, acoustic signatures, detection timestamps, estimated bearings, triangulated positions, and confidence scores associated with detected wildlife sounds. In some instances, the wildlife data 435B may further include individual animal profiles generated from recurring acoustic signatures that allow the system 400 to track specific animals over time. The user profile 435 provides a centralized repository for organizing and accessing the various types of information generated by the system 400.

Path data 435C stored within the user profile 435 may include inferred travel routes, movement tracks, recurring corridors, and historical path information derived from aggregated triangulated positions over a plurality of time periods. In a preferred embodiment, the path data 435C may represent common travel routes such as roost-to-feeding routes, bedding-to-water routes, crossing points, corridors, strut zones, calling stations, and other recurring wildlife paths identified by the system 400. Environmental data 435D stored within the user profile 435 may include contextual information that can influence wildlife movement and vocalization patterns. Environmental and contextual inputs for movement prediction may include sunrise and sunset, moon phase, temperature, barometric pressure, precipitation, terrain features, vegetation cover, water sources, crop cycles, hunting pressure, and prior detections on neighboring field units 406. In some preferred embodiments, the system 400 may correlate the environmental data 435D with the wildlife data 435B and path data 435C to improve prediction accuracy. The database 115 maintains the user profile 435 and associated data categories in a manner that supports retrieval and analysis by the server 110.

As illustrated in FIG. 4, the system 400 comprises a non-transitory computer-readable medium 440 coupled to the processor 220, wherein the non-transitory computer-readable medium 440 contains instructions stored thereon, which, when executed by the processor 220, cause the processor 220 to perform operations associated with wildlife detection and localization. In a preferred embodiment, the non-transitory computer-readable medium 440 may store instructions for receiving detection data from the plurality of field units 406, correlating detections from at least two field units 406 that correspond to a same sound event, triangulating a geographic position of a sound source, and generating movement information based on a plurality of triangulated positions over time. The processor 220 may execute the instructions stored on the non-transitory computer-readable medium 440 to perform classification, individual recognition, path inference, and predictive analysis operations. In some instances, the predictive models executed by the processor 220 may be personalized for a specific property based on accumulated detection data and user feedback. Alternatively, the predictive models may be initialized from broader regional datasets and then adapted through continued local use on the property of the user 405. The non-transitory computer-readable medium 440 coupled to the processor 220 enables the system 400 to perform the various detection, triangulation, tracking, and visualization operations described herein.

As illustrated in FIG. 5, the present disclosure describes the physical configuration of the field unit 406 for distributed acoustic wildlife detection and localization. In a preferred embodiment, the field unit 406 comprises a body 502 that serves as the main housing structure and provides structural support for the internal and external components of the field unit 406. The body 502 may be configured to withstand outdoor environmental conditions including rain, humidity, temperature variations, dust, and debris that may be encountered during extended deployment in hunting areas, conservation areas, ranches, or other geographic locations. The body 502 can be constructed from weather-resistant materials such as injection-molded plastics, composite materials, or other durable substances suitable for outdoor use. In some instances, the body 502 may include sealing features such as gaskets, O-rings, or weatherstripping to protect internal electronic components from moisture ingress. The body 502 provides the foundation upon which the various functional components of the field unit 406 are mounted and organized.

With continued reference to FIG. 5, the field unit 406 comprises a door 504 positioned adjacent to the body 502 that provides access to internal components of the field unit 406. In a preferred embodiment, the door 504 may be hinged to the body 502 to allow the door 504 to swing open and closed, thereby permitting a user 405 to access internal storage, batteries, or configuration interfaces. The door 504 can be constructed from the same weather-resistant materials as the body 502 to maintain environmental protection when the door 504 is in a closed position. In some preferred embodiments, the door 504 may include sealing elements along the perimeter of the door 504 to prevent water and debris from entering the interior of the field unit 406 when the door 504 is secured. Alternatively, the door 504 may be removable rather than hinged, depending on the design configuration of the field unit 406. The door 504 facilitates maintenance operations such as battery replacement, memory card retrieval, and visual inspection of internal components.

As further shown in FIG. 5, the field unit 406 comprises a screen 506 located on an upper portion of the field unit 406 that may be configured to display status information, configuration settings, and operational data to the user 405. In a preferred embodiment, the screen 506 may comprise a liquid crystal display (LCD) or other display technology suitable for outdoor visibility under varying lighting conditions. The screen 506 can display information such as battery level, signal strength, detection counts, operational mode, and error indicators that assist the user 405 in monitoring the status of the field unit 406 during deployment. In some instances, the screen 506 may be positioned inside an enclosure accessible through the door 504, which can protect the screen 506 from direct exposure to environmental elements while still allowing the user 405 to view displayed information when the door 504 is open. Alternatively, the screen 506 may be positioned on an exterior surface of the body 502 with appropriate protective covering to allow viewing without opening the door 504. The screen 506 provides a local interface for the user 405 to verify proper operation of the field unit 406 without requiring connection to the mobile computing device 410.

In another preferred embodiment, the field unit 406 comprises a microphone 508 positioned at the top of the field unit 406 and configured to capture acoustic signals from the surrounding environment, as illustrated in FIG. 5. The microphone 508 forms part of a microphone array having a plurality of microphones arranged in a known geometry, wherein the known geometry enables the processor 220 of the field unit 406 to determine an estimated bearing to a sound source based on signals received by the plurality of microphones. In some preferred embodiments, the microphones in the microphone array may be directional microphones rather than omnidirectional microphones, which can provide enhanced sensitivity in particular directions and improved rejection of sounds arriving from other directions. Alternatively, the microphones in the microphone array may be omnidirectional microphones with direction computed from array geometry and signal processing techniques such as time difference of arrival, phase difference, amplitude difference, or beamforming. The processor 220 may be configured to determine the estimated bearing based on at least one of time difference of arrival, phase difference, amplitude difference, or beamforming, as described previously. The microphone 508 and associated microphone array components enable the field unit 406 to receive acoustic signals from a sound source and determine directional information that supports triangulation when multiple field units 406 detect the same sound event.

In some preferred embodiments, the field unit 406 comprises a speaker configured to emit sounds into the surrounding environment for purposes of attracting wildlife or eliciting vocalizations from animals within the geographic area. The speaker may be positioned on the body 502 in a location that provides adequate sound projection while maintaining protection from environmental exposure. In a preferred embodiment, the speaker may be configured to produce wildlife vocalizations such as turkey hen yelps, gobbler gobbles, deer grunts, elk cow calls, predator distress sounds, or other species-specific calls that can attract target animals toward the field unit 406 or stimulate vocal responses that the microphone array can detect and localize. The speaker may be controlled remotely by the user 405 through the user interface 411 of the mobile computing device 410, allowing the user 405 to initiate call sequences from a distance without approaching the field unit 406 and potentially disturbing wildlife in the area. Alternatively, the speaker may be configured to operate automatically according to programmed schedules or in response to detected wildlife activity, such as emitting a hen yelp sequence when a gobble is detected within a specified range. In some instances, the speaker may be used in conjunction with the microphone array to create a closed-loop system wherein the field unit 406 emits a call, monitors for responses, and adjusts subsequent calling strategies based on the acoustic feedback received from the environment. The speaker functionality enables the field unit 406 to serve as both a passive listening device and an active wildlife interaction tool that can enhance detection opportunities by encouraging animals to vocalize.

As illustrated in FIG. 5, the field unit 406 comprises a Mini SDHC card port 510 located on the body 502 to provide removable storage capability for the field unit 406. In a preferred embodiment, the Mini SDHC card port 510 may be configured to accept a Mini SDHC memory card or similar removable storage medium that can store audio recordings, detection logs, configuration data, and other information generated by the field unit 406. The Mini SDHC card port 510 allows the user 405 to retrieve stored data by removing the memory card and accessing the data using a computing device 300 or mobile computing device 350 equipped with a compatible card reader. In some instances, the field unit 406 may send raw audio clips to the server 110 rather than compressed audio or extracted features, and the Mini SDHC card port 510 can provide local backup storage for such raw audio data. Alternatively, the field unit 406 may send compressed audio to the server 110 rather than raw audio or extracted features, which can reduce bandwidth consumption during wireless transmission. In another preferred embodiment, the field unit 406 may send extracted features or event metadata such as time, estimated bearing, confidence score, and species classification to the server 110, with the Mini SDHC card port 510 providing supplemental storage for detailed recordings that may be retrieved later for analysis or model training purposes.

With continued reference to FIG. 5, the field unit 406 comprises a belt 512 extending from an upper rear portion of the body 502 to facilitate mounting or carrying of the field unit 406 in outdoor environments. In a preferred embodiment, the belt 512 may comprise a strap with hook and loop fasteners or other securing mechanisms that allow the user 405 to attach the field unit 406 to trees, posts, fence rails, or other structures commonly found in hunting areas, ranches, and conservation areas. The belt 512 can be adjusted in length to accommodate attachment points of varying circumference, which provides flexibility in positioning the field unit 406 at different locations across the geographic area. In some preferred embodiments, the belt 512 may be constructed from weather-resistant materials such as nylon webbing or reinforced fabric that can withstand prolonged outdoor exposure without degradation. Alternatively, the belt 512 may be removable from the body 502 to allow the user 405 to substitute different mounting accessories depending on the deployment scenario. The belt 512 enables the plurality of field units 406 to be positioned at spaced locations across the geographic area in a manner that creates overlapping listening zones for wildlife detection and localization.

As further shown in FIG. 5, the field unit 406 comprises a cover 514 positioned to the side of the body 502 that provides protection for internal components or access points of the field unit 406. In a preferred embodiment, the cover 514 may be configured to protect ports, connectors, or other interface elements from environmental exposure when the interface elements are not in active use. The cover 514 can be hinged, removable, or slidable depending on the design configuration of the field unit 406 and the type of interface element being protected. In some instances, the cover 514 may include a sealing gasket or other weatherproofing feature that prevents moisture ingress when the cover 514 is in a closed position. Alternatively, the cover 514 may be tethered to the body 502 to prevent loss of the cover 514 during field operations when the cover 514 is opened to access underlying components. The cover 514 contributes to the overall environmental protection of the field unit 406 during extended outdoor deployment.

In another preferred embodiment, the field unit 406 comprises a lock 516 visible on the body 502 that provides security functionality to prevent unauthorized access to the field unit 406, as illustrated in FIG. 5. The lock 516 may be configured to secure the door 504 in a closed position, which can prevent tampering, theft, or unauthorized retrieval of stored data from the field unit 406 when the field unit 406 is deployed in remote or unattended locations. In some preferred embodiments, the lock 516 may comprise a magnetic clasp, combination lock, keyed lock, or other securing mechanism suitable for outdoor equipment. The lock 516 can deter unauthorized persons from accessing the internal components, memory cards, or batteries of the field unit 406 during the deployment period. Alternatively, the lock 516 may be integrated with the door 504 as a latching mechanism that secures the door 504 without requiring a separate key or combination. The lock 516 provides the user 405 with confidence that the field unit 406 and associated detection data will remain secure during extended unattended operation.

As illustrated in FIG. 5, the field unit 406 comprises a USB Type-C port 518 located on a lower portion of the body 502 that enables data transfer and charging capabilities for the field unit 406. In a preferred embodiment, the USB Type-C port 518 may be configured to connect the field unit 406 to a computing device 300, mobile computing device 350, or external power source for purposes of data synchronization, firmware updates, configuration changes, or battery charging. The USB Type-C port 518 provides a standardized interface that can be used with commonly available cables and chargers, which simplifies field maintenance and reduces the need for proprietary accessories. In some instances, the USB Type-C port 518 may be positioned beneath the cover 514 to protect the USB Type-C port 518 from environmental exposure when the USB Type-C port 518 is not in active use. Alternatively, the USB Type-C port 518 may include an integrated protective flap or plug that seals the USB Type-C port 518 against moisture and debris. The USB Type-C port 518 enables the user 405 to charge the field unit 406 using portable power banks or vehicle chargers when solar charging or other power sources are unavailable, thereby supporting extended deployment of the field unit 406 in remote locations.

As illustrated in FIG. 6, the present disclosure describes additional views and deployment configurations of the field unit 406 for distributed acoustic wildlife detection and localization. In a preferred embodiment, the upper portion of FIG. 6 depicts two isometric views of the assembled field unit 406 showing a compact rectangular housing with product identification displayed on an exterior surface, which allows the user 405 to visually identify the field unit 406 during deployment and retrieval operations. The compact rectangular housing may be configured to facilitate transport and positioning of multiple field units 406 across a geographic area such as a hunting property, ranch, conservation area, or wildlife research site. In some instances, the compact form factor of the field unit 406 enables the user 405 to carry several field units 406 simultaneously when establishing a distributed acoustic sensing network across the terrain. The assembled views shown in FIG. 6 demonstrate the integrated construction of the field unit 406 with the various functional components contained within the weather-resistant housing. Alternatively, the field unit 406 may be provided in different housing configurations depending on the deployment environment and aesthetic preferences of the user 405.

With continued reference to FIG. 6, the lower portion of the figure presents annotated detail views highlighting deployment features of the field unit 406 that support outdoor installation in the distributed acoustic sensing network. In a preferred embodiment, the field unit 406 includes a hinged front door that provides access to internal components while maintaining environmental protection when the hinged front door is secured in a closed position. The annotated detail views further illustrate straps with hook and loop fasteners that enable the user 405 to mount the field unit 406 to trees, posts, fence rails, and other vertical structures commonly found in outdoor environments where wildlife detection is performed. In some preferred embodiments, the straps with hook and loop fasteners may be adjusted to accommodate attachment points of varying circumference, which provides flexibility in positioning the field unit 406 at different heights and orientations to optimize acoustic coverage for the target wildlife species. The mounting features shown in FIG. 6 enable the plurality of field units 406 to be positioned at spaced locations across the geographic area in a manner that creates overlapping listening zones for triangulation of wildlife sounds. The physical spacing and orientation of the field units 406 across the terrain can be selected to improve bearing accuracy and overall coverage for the intended species and terrain characteristics.

In another preferred embodiment, the annotated detail views of FIG. 6 illustrate a battery door on the back of the field unit 406 that covers two rechargeable lithium batteries for portable power during extended field operation. The battery door may be configured to provide secure access to the battery compartment while maintaining weather resistance when the battery door is closed and latched. In some instances, the rechargeable lithium batteries may provide sufficient power for the field unit 406 to operate continuously for extended periods ranging from days to weeks depending on the operational mode, detection frequency, and transmission activity of the field unit 406. The battery compartment configuration shown in FIG. 6 allows the user 405 to replace depleted batteries with charged batteries in the field without returning the field unit 406 to a base location for recharging. Alternatively, the field unit 406 may include a solar charging system that supplements or replaces the rechargeable lithium batteries, which can extend operational duration in remote locations without access to electrical infrastructure or frequent battery replacement. The power source configuration of the field unit 406 supports extended unattended operation that is characteristic of distributed acoustic sensing networks deployed across large geographic areas.

As further shown in FIG. 6, the field unit 406 includes an LCD display inside the enclosure that presents status information and operational data to the user 405 when the hinged front door is opened. In a preferred embodiment, the LCD display may be configured to show battery level, signal strength, detection counts, operational mode, and configuration settings that assist the user 405 in verifying proper operation of the field unit 406 during deployment and maintenance visits. The positioning of the LCD display inside the enclosure protects the LCD display from direct exposure to environmental elements such as rain, dust, and ultraviolet radiation while still allowing the user 405 to view displayed information when access is needed. In some preferred embodiments, the LCD display may present information regarding the synchronized clock of the field unit 406, which timestamps detections to enable the server 110 to match detections from the plurality of field units 406 across the distributed network. The synchronized clock may be configured to timestamp detections with precision that supports correlation of sound events detected by multiple field units 406 positioned at different locations across the geographic area. The timestamps generated by the synchronized clock enable the server 110 to determine whether detections from at least two field units 406 correspond to a same sound event, which is a prerequisite for triangulating the geographic position of the sound source.

In another preferred embodiment, the annotated detail views of FIG. 6 illustrate multiple microphones arranged on the housing of the field unit 406 for directional sound detection as part of the microphone array described previously. The multiple microphones may be positioned at known geometric locations on the housing to enable the processor 220 of the field unit 406 to determine an estimated bearing to a sound source based on time difference of arrival, phase difference, amplitude difference, beamforming, or a combination of these techniques. In some instances, the arrangement of the multiple microphones on the housing may be optimized for detection of wildlife vocalizations within particular frequency ranges associated with target species such as turkeys, coyotes, elk, or other vocalizing animals. The microphone arrangement shown in FIG. 6 enables each field unit 406 to determine directional information that supports triangulation when the same sound event is detected by multiple field units 406 positioned at spaced locations across the geographic area. Alternatively, the microphone arrangement may be configured for omnidirectional sensitivity with direction computed from array geometry and signal processing rather than from directional microphone elements. The multiple microphones and associated signal processing capabilities enable the field unit 406 to provide estimated bearings that the server 110 uses to triangulate geographic positions of wildlife sound sources.

As illustrated in FIG. 6, the annotated detail views further show a magnetic clasp securing the front door of the field unit 406 and a charging port that enables power replenishment during field deployment. In a preferred embodiment, the magnetic clasp may be configured to secure the hinged front door in a closed position while allowing the user 405 to open the hinged front door without tools or complex manipulation, which facilitates rapid access during field maintenance operations. The charging port shown in FIG. 6 may correspond to the USB Type-C port 518 described previously, which enables the user 405 to charge the rechargeable lithium batteries using portable power banks, vehicle chargers, or other external power sources when solar charging is unavailable or insufficient. In some preferred embodiments, at least one field unit 406 further comprises a sound emitter configured to produce sounds into an environment, wherein the sounds include at least one of wildlife vocalizations, calibration signals, or test tones. The sound emitter may be integrated within the housing of the field unit 406 or may be provided as a separate component that connects to the field unit 406 through a wired or wireless interface. The sound emitter can produce wildlife vocalizations such as turkey hen calls, coyote vocalizations, wild hog sounds, or other species-specific sounds that may attract or elicit responses from wildlife in the vicinity of the field unit 406.

In some preferred embodiments, the sound emitter is controllable remotely through a user interface 411 operably connected to the server 110, which allows the user 405 to initiate sound playback from a mobile computing device 410 without physically visiting the location of the field unit 406. The remote control capability enables the user 405 to emit sounds at strategic times based on detection data received from the distributed network of field units 406 positioned across the geographic area. Alternatively, the sound emitter may be controlled locally through the user interface presented on the LCD display of the field unit 406, or the sound emitter may be controlled automatically according to a rule set in response to detected wildlife activity. In some instances, the sound emitter may emit a turkey hen call after detecting a gobble within a selected distance, which can attract the vocalizing turkey toward the location of the field unit 406 or toward a hunting position selected by the user 405. The sound emitter may play a sound sequence according to a user-defined schedule that specifies particular times, durations, and sound types for automated playback during deployment periods. The automated control capabilities of the sound emitter enable the system 400 to interact with wildlife in a manner that supports hunting, research, and observation objectives without continuous manual intervention by the user 405.

In another preferred embodiment, the system 400 may evaluate the response to an emitted sound to measure whether an animal moved closer, moved away, or vocalized in response to the sound produced by the sound emitter. The microphone array of the field unit 406 that emitted the sound can capture subsequent acoustic signals from the environment and the processor 220 can analyze the subsequent acoustic signals to determine changes in the estimated bearing, distance, or vocalization pattern of the detected animal. In some instances, the system 400 may learn which emitted calls are most likely to generate a response under particular conditions and may adjust call timing, call type, call sequence, or volume based on prior outcomes observed during previous playback events. The adaptive learning capability enables the system 400 to improve the effectiveness of sound emission over time as additional response data is accumulated from the geographic area. Alternatively, the system 400 may infer when no playback should occur because the detected animal is moving away, because legal or user-defined constraints apply, or because the confidence in species classification is too low to justify sound emission. The response evaluation and adaptive control features create a closed-loop wildlife interaction capability that integrates the sound emission function with the localization and tracking features of the system 400.

As further shown in FIG. 6, the deployment configuration of the field unit 406 supports compliance and record-keeping features associated with sound emission in various jurisdictions and use contexts. In a preferred embodiment, the system 400 may include legal-compliance controls based on jurisdiction for sound emission, which can restrict or disable certain playback modes depending on the geographic location of the field unit 406 and applicable regulations governing the use of electronic calls for hunting or wildlife management. The system 400 may include logging of emitted sounds for record-keeping, which creates an auditable record of sound playback events including timestamps, sound types, durations, and volumes that can be reviewed by the user 405 or provided to regulatory authorities if requested. In some preferred embodiments, the system 400 may include disablement of certain playback modes based on configuration settings established by the user 405 or by an administrator 965 with appropriate permission levels 900 within the system 400. The compliance and logging features enable the system 400 to be configured for non-hunting uses such as wildlife research, conservation, depredation control, and habitat monitoring where different regulatory frameworks may apply. Alternatively, the compliance controls may be configured to enable full playback functionality in jurisdictions where electronic calls are permitted for the target species and hunting method. The configurable compliance features of the system 400 support deployment across diverse geographic areas with varying regulatory requirements while maintaining appropriate documentation of sound emission activities.

In a preferred embodiment, the present disclosure describes machine learning training methods and approaches for the various models used in the wildlife detection and localization system. The machine learning model may use supervised learning with labeled recordings, wherein the labeled recordings comprise audio samples that have been annotated with species identification, call type, location information, and other metadata by human reviewers or automated labeling systems. Supervised learning approaches can train the machine learning classification model on a dataset of wildlife vocalizations comprising a plurality of species-specific acoustic samples, wherein the species-specific acoustic samples include recordings of turkey gobbles, coyote howls, elk bugles, duck calls, hog squeals, and other target wildlife sounds collected from field deployments or curated audio libraries. In some instances, the labeled recordings may include negative examples such as wind noise, rain noise, thunder, insects, livestock, vehicles, human voices, gunshots, machinery, and overlapping wildlife calls that the model learns to distinguish from target wildlife sounds. The supervised learning approach enables the model to learn discriminative features that separate target species vocalizations from non-target sounds and background interference commonly encountered in outdoor acoustic environments. The training dataset for supervised learning may be augmented with synthetic variations of the labeled recordings, including time-stretched versions, pitch-shifted versions, and recordings with added background noise to improve model robustness across varying field conditions.

In another preferred embodiment, the machine learning model may use semi-supervised learning to discover recurring acoustic patterns from field recordings that include both labeled and unlabeled data. Semi-supervised learning approaches can leverage large quantities of unlabeled field recordings collected by the distributed network of field units while incorporating the discriminative information provided by a smaller set of labeled recordings that have been annotated with species identification and call type. In some preferred embodiments, the semi-supervised learning approach may use consistency regularization techniques that encourage the model to produce similar predictions for unlabeled recordings and augmented versions of the same unlabeled recordings. The semi-supervised approach can reduce the annotation burden associated with creating large labeled datasets while still achieving classification performance that approaches fully supervised methods. Alternatively, the semi-supervised learning approach may use pseudo-labeling techniques wherein the model generates provisional labels for unlabeled recordings based on high-confidence predictions, and the provisionally labeled recordings are then incorporated into subsequent training iterations. The semi-supervised training methodology enables the system to benefit from the large volume of acoustic data captured by field units deployed across diverse geographic areas without requiring manual annotation of each captured recording.

In some preferred embodiments, the machine learning model may use self-supervised learning to discover recurring acoustic patterns from large sets of field recordings without relying on explicit labels provided by human annotators. Self-supervised learning approaches can train the model to predict masked portions of spectrograms, to distinguish between temporally adjacent audio segments and non-adjacent segments, or to learn representations that capture acoustic similarity between different recordings of the same sound event. The self-supervised pretraining phase enables the model to learn general acoustic features from unlabeled field recordings, and the pretrained model can then be fine-tuned on a smaller set of labeled recordings for specific classification tasks such as species identification or call type recognition. In some instances, the self-supervised approach may use contrastive learning objectives that encourage the model to produce similar representations for augmented versions of the same recording while producing dissimilar representations for different recordings. The self-supervised training methodology can extract useful acoustic representations from field recordings collected across different habitats, seasons, weather conditions, and animal populations without requiring species labels or call type annotations during the initial representation learning phase. Alternatively, the self-supervised approach may use predictive objectives wherein the model learns to predict future audio frames from past audio frames, which can capture temporal dynamics characteristic of wildlife vocalizations.

In a preferred embodiment, the machine learning model may use unsupervised learning to discover recurring acoustic patterns from large sets of field recordings collected by the distributed network of field units. Unsupervised learning approaches can cluster field recordings based on acoustic similarity without requiring labeled examples, which enables the system to identify recurring sound patterns that may correspond to particular species, call types, or individual animals. In some instances, the unsupervised clustering may reveal acoustic patterns that were not anticipated during system design, such as previously unrecognized call variants, hybrid vocalizations, or sounds produced by non-target species that share acoustic characteristics with target species. The unsupervised approach can group recordings into clusters that a human reviewer may subsequently label, thereby creating a semi-automated annotation workflow that reduces the manual effort associated with building labeled training datasets. Alternatively, the unsupervised learning approach may use dimensionality reduction techniques to project high-dimensional acoustic features into lower-dimensional representations that can be visualized and explored by researchers studying wildlife vocalization patterns. The unsupervised training methodology enables the system to adapt to acoustic environments and wildlife populations that differ from the environments and populations represented in initial training datasets.

In another preferred embodiment, the machine learning model may be updated periodically as additional recordings are collected from the user's property or from a larger shared dataset covering different habitats, seasons, weather conditions, and animal populations. The periodic model updates can incorporate newly collected field recordings that capture acoustic variations not represented in earlier training datasets, such as recordings from different times of year, different weather conditions, or different geographic regions with distinct wildlife populations. In some preferred embodiments, the model update process may use incremental learning techniques that add new knowledge to the model without forgetting previously learned patterns, which enables the model to improve over time as the system accumulates additional field data. The shared dataset covering different habitats, seasons, weather conditions, and animal populations can provide a broader foundation for model training than recordings collected from a single property, which can improve generalization performance when the system is deployed in new geographic areas. Alternatively, the model update process may use transfer learning techniques wherein a model trained on the larger shared dataset is fine-tuned on recordings collected from the user's property to adapt the model to local acoustic conditions and wildlife populations. The periodic update methodology enables the system to benefit from continued data collection across the distributed network of field units while maintaining classification accuracy as environmental conditions and wildlife populations change over time.

In some preferred embodiments, the present disclosure describes the generation of acoustic signatures and comparison methods for individual animal recognition using machine learning feature extraction and similarity models. The server may be configured to generate, using a machine learning feature extraction model, an acoustic signature associated with an individual animal based on at least one of frequency content, cadence, harmonic structure, temporal spacing, call length, or amplitude envelope extracted from detected vocalizations. The machine learning feature extraction model can produce an embedding or feature vector that captures the distinctive acoustic characteristics of a particular vocalizing animal, such as a specific turkey gobbler with a recognizable gobble pattern or a coyote with a distinctive howl structure. In some instances, the acoustic signature may be stored in a database and associated with a persistent identity profile that accumulates additional detections attributed to the same individual animal over time. The system may be configured to compare, using a machine learning similarity model, a subsequent detection with the acoustic signature to determine whether the subsequent detection corresponds to the individual animal previously identified. The comparison process can produce a similarity score or confidence value that indicates the likelihood that the subsequent detection originated from the same individual animal, a different animal of the same species, or an unknown source.

In a preferred embodiment, the machine learning similarity model may use distance metrics in the embedding space to quantify acoustic similarity between a subsequent detection and stored acoustic signatures associated with previously identified individual animals. The similarity model can rank candidate matches by similarity score and present the highest-scoring matches to the user through the user interface, optionally with confidence indicators that reflect the reliability of the identity determination. In some preferred embodiments, the user may confirm or reject suggested identities through the user interface, and the confirmation or rejection feedback can be incorporated into later model updates to improve recognition accuracy over time. The individual animal recognition capability enables the system to maintain separate tracks for different animals using the same property at the same time, which provides the user with more detailed information about wildlife activity than aggregate species-level detection counts. Alternatively, the similarity model may use learned distance functions that are trained to distinguish between same-individual pairs and different-individual pairs using labeled examples of matched and unmatched vocalizations. The acoustic signature generation and comparison methods enable the system to track specific animals across multiple detection events and to identify recurring patterns of individual animal behavior within the geographic area.

In another preferred embodiment, the present disclosure describes the generation of heat maps, line overlays, or probability zones representing recurring travel routes using machine learning pattern recognition models applied to aggregated triangulated positions. The server may be configured to generate, using a machine learning pattern recognition model, at least one of a heat map, a line overlay, or a probability zone representing recurring travel routes on a geospatial map based on aggregated triangulated positions over a plurality of time periods. The machine learning pattern recognition model can analyze the spatial and temporal distribution of triangulated wildlife positions to identify corridors, crossing points, and areas of concentrated activity that indicate repeated use by wildlife over days, weeks, or seasons. In some instances, the heat map representation may display detection density using color gradients that indicate areas of high activity versus areas of low activity, which enables the user to identify hotspots where wildlife is frequently detected. The line overlay representation may display inferred travel routes as connected path segments that show the direction and sequence of wildlife movement across the geographic area. The probability zone representation may display areas where wildlife is likely to be present based on historical detection patterns and environmental factors, which can support predictive planning for hunting, observation, or research activities.

In some preferred embodiments, the machine learning pattern recognition model may incorporate terrain features, vegetation cover, water sources, and other environmental variables when generating the heat maps, line overlays, or probability zones representing recurring travel routes. The pattern recognition model can learn associations between wildlife movement patterns and landscape features such as ridgelines, drainages, field edges, timber boundaries, and water access routes that influence where animals travel within the geographic area. In some instances, the model may generate separate visualizations for different time periods, such as morning versus evening activity patterns, or for different seasons, such as breeding season versus non-breeding season movement patterns. The aggregated triangulated positions over a plurality of time periods provide the input data for the pattern recognition model, and the model can identify statistically recurring patterns that may not be apparent from individual detection events viewed in isolation. Alternatively, the pattern recognition model may generate probabilistic predictions of future wildlife locations based on current detections and historical movement patterns, which can inform real-time decision-making by the user. The heat map, line overlay, and probability zone generation capabilities enable the system to transform raw detection data into actionable geospatial visualizations that support wildlife management, hunting, research, and conservation objectives.

In a preferred embodiment, the present disclosure describes machine learning models that may be trained to estimate direction of arrival, range, or location probability using combined outputs of multiple microphones, multiple field units, and contextual variables that influence acoustic propagation in outdoor environments. The machine learning model may receive inputs from the microphone array of each field unit, including time difference of arrival measurements, phase difference measurements, amplitude difference measurements, and beamformed outputs that capture directional information about detected sounds. The contextual variables for machine learning may include terrain, vegetation, wind, temperature, humidity, and known microphone placement, wherein these variables can affect how sound travels from a wildlife source to the microphones of the distributed field units. In some instances, the machine learning model may learn correlations between environmental conditions and acoustic propagation characteristics that enable more accurate estimation of sound source location than traditional signal processing methods that do not account for environmental variability. The model may receive terrain data indicating elevation changes, ridgelines, valleys, and other topographic features that can reflect, absorb, or channel sound waves in predictable ways. Alternatively, the model may receive vegetation data indicating forest density, canopy height, understory thickness, and seasonal foliage conditions that affect sound attenuation and scattering between the wildlife source and the field units.

In another preferred embodiment, the machine learning model may learn to compensate for echo, reverberation, terrain shadowing, partial occlusion, microphone mismatch, or other distortions that can reduce accuracy in wooded, hilly, or wet environments where wildlife detection is performed. Echo compensation may involve training the model to distinguish between direct sound arrivals and reflected sound arrivals that reach the microphones after bouncing off terrain features, tree trunks, rock faces, or other reflective surfaces in the acoustic environment. Reverberation compensation may involve training the model to account for the diffuse sound energy that persists after the initial sound event due to multiple reflections within enclosed or semi-enclosed spaces such as valleys, ravines, or dense forest stands. In some preferred embodiments, the model may learn to compensate for terrain shadowing that occurs when hills, ridges, or other elevated terrain features block the direct acoustic path between the wildlife source and one or more field units. Partial occlusion compensation may involve training the model to account for situations where vegetation, structures, or terrain partially block the acoustic path without completely eliminating sound transmission. Microphone mismatch compensation may involve training the model to account for variations in sensitivity, frequency response, or directional characteristics among the microphones within a single field unit or across multiple field units in the distributed network.

In some preferred embodiments, the system may generate a probabilistic location surface rather than a single point estimate when triangulating the geographic position of a wildlife sound source. The probabilistic location surface can represent the uncertainty in the location estimate by assigning probability values to different geographic coordinates based on the quality of the detection data, the geometry of the detecting field units, and the environmental conditions at the time of detection. In some instances, the probabilistic location surface may be refined as additional sound events are detected from the same animal, wherein each subsequent detection provides additional information that narrows the uncertainty region and increases confidence in the estimated location. The machine learning model may rank or weight candidate triangulations by confidence so that lower-quality detections do not distort the resulting track when multiple detections are combined to infer movement patterns. Alternatively, the model may use Bayesian updating techniques to combine prior location estimates with new detection data in a manner that appropriately weights the reliability of each information source. The probabilistic approach enables the system to communicate location uncertainty to the user through the user interface, which can inform decisions about how to interpret and act upon the detection information.

In a preferred embodiment, the present disclosure describes sequential models that may be used to predict where an animal is likely to move next after one or more detections have been recorded by the distributed network of field units. Sequential models such as hidden Markov models may be used to predict where an animal is likely to move next by modeling wildlife movement as a sequence of transitions between discrete location states with probabilistic transition dynamics learned from historical detection data. Sequential models such as recurrent neural networks may be used to predict where an animal is likely to move next by processing sequences of detection events through neural network architectures that maintain internal state representations capturing temporal dependencies in wildlife movement patterns. Sequential models such as transformers may be used to predict where an animal is likely to move next by applying attention mechanisms that can capture long-range dependencies between detection events separated by extended time intervals. In some instances, sequential models such as Bayesian trackers may be used to predict where an animal is likely to move next by maintaining probability distributions over possible animal locations and updating these distributions as new detections arrive. Sequential models such as particle filters may be used to predict where an animal is likely to move next by representing location uncertainty through collections of weighted particles that are propagated forward in time according to learned movement dynamics and reweighted based on detection observations.

In another preferred embodiment, the machine learning trajectory prediction model may generate outputs including a projected direction of travel, an estimated future location, or a map layer showing high-probability routes based on prior behavior and current conditions observed for the detected wildlife. The trajectory prediction model may incorporate environmental and contextual inputs including sunrise and sunset times, moon phase, temperature, barometric pressure, precipitation, terrain features, vegetation cover, water sources, crop cycles, hunting pressure, and prior detections on neighboring field units when generating movement predictions. In some preferred embodiments, the trajectory prediction model may learn repeated movement patterns for turkey applications such as roost departure timing, mid-morning travel routes, strut zone usage patterns, and return routes that turkeys follow on a recurring basis within the geographic area. The model may be adapted for elk bugling movement by learning the spatial and temporal patterns associated with bull elk vocalizations during the breeding season, including travel circuits between calling locations and responses to competing bulls. Alternatively, the model may be adapted for coyote travel circuits by learning the territorial patrol patterns and hunting routes that coyotes follow within their home ranges. The model may further be adapted for duck use of wetlands by learning the flight patterns, landing zones, and feeding area preferences that ducks exhibit within wetland habitats monitored by the distributed field units.

In some preferred embodiments, the present disclosure describes vocalization embedding extraction methods for individual animal recognition using machine learning feature extraction models that process detected vocalizations to generate compact representations capturing distinctive acoustic characteristics. The machine learning model may extract an embedding or feature vector from a detected vocalization, wherein the embedding captures acoustic features that distinguish one individual animal from other individuals of the same species based on the unique characteristics of that animal's vocalizations. The machine learning feature extraction model may generate an acoustic signature associated with an individual animal based on at least one of frequency content, cadence, harmonic structure, temporal spacing, call length, or amplitude envelope, as described previously. In some instances, the embedding extraction process may use deep neural network architectures trained to map variable-length vocalization recordings to fixed-length vector representations that can be compared using distance metrics in the embedding space. The system may update a persistent identity profile when similarity between detections exceeds a threshold, wherein the persistent identity profile accumulates detection events attributed to the same individual animal and tracks that individual's movement patterns over time. Alternatively, the system may create new identity profiles when detected vocalizations do not match existing profiles with sufficient similarity, thereby expanding the database of recognized individuals as new animals are detected within the geographic area.

In a preferred embodiment, the present disclosure describes turkey call differentiation capabilities wherein the machine learning model may differentiate between gobbles, clucks, yelps, purrs, cutts, fly-down sounds, wing beats, or drumming-related acoustic events produced by turkeys within the monitored geographic area. Gobble detection may involve recognizing the distinctive low-frequency vocalization produced by male turkeys that carries over long distances and serves as a primary indicator of gobbler presence and location. Cluck detection may involve recognizing the short, staccato vocalizations that turkeys produce during feeding, movement, and social interaction with other turkeys in the flock. Yelp detection may involve recognizing the rhythmic series of notes that hen turkeys produce for communication purposes and that hunters may imitate using calls to attract gobblers. In some instances, purr detection may involve recognizing the soft, rolling vocalizations that turkeys produce when content or feeding, which can indicate turkey presence even when louder vocalizations are absent. Cutt detection may involve recognizing the loud, sharp, irregular series of notes that excited hens produce, which can indicate heightened activity levels within the turkey population. Fly-down sound detection may involve recognizing the wing beat sounds and associated vocalizations that turkeys produce when leaving roost trees in the morning, which can indicate roost locations and departure timing. Drumming-related acoustic event detection may involve recognizing the low-frequency sounds produced by strutting gobblers, which can indicate strut zone locations and breeding activity within the geographic area.

In another preferred embodiment, the system may allow the user to confirm or reject suggested identities through the user interface, and that feedback may be incorporated into later model updates to improve recognition accuracy over time. The user feedback mechanism enables the machine learning models to learn from corrections provided by users who have additional knowledge about the wildlife population within the geographic area, such as visual observations that confirm or contradict acoustic identity assignments. In some preferred embodiments, the confirmed identity assignments may be added to the training dataset for subsequent model updates, which can improve the model's ability to distinguish between individual animals as the dataset grows with continued system use. The rejected identity assignments may similarly inform model training by providing negative examples that indicate when the model incorrectly matched detections to existing identity profiles. Alternatively, the user feedback may be weighted based on the confidence level of the original identity assignment, with corrections to high-confidence assignments receiving greater weight in model updates than corrections to low-confidence assignments. The iterative feedback and retraining process enables the individual animal recognition capabilities to improve over time as the system accumulates additional detection data and user corrections from the geographic area.

In some preferred embodiments, the present disclosure describes edge transmission decisions wherein an edge model running on the field unit may decide whether a captured sound should be discarded, stored locally, transmitted immediately, or escalated for cloud analysis based on multiple factors including detection confidence, signal quality, and resource constraints. The edge model may evaluate each captured sound event and assign the sound event to one of several processing pathways based on the characteristics of the detection and the current operational state of the field unit. In some instances, the edge model may discard captured sounds that are classified as non-target noise with high confidence, such as wind gusts, rain impacts, or vehicle sounds that do not warrant storage or transmission. The edge model may store captured sounds locally on the Mini SDHC card when the sounds have moderate confidence scores that warrant preservation for later review but do not justify immediate transmission over bandwidth-limited communication links. Alternatively, the edge model may transmit captured sounds immediately when the sounds are classified as high-confidence target wildlife vocalizations that the user has indicated should trigger real-time alerts through the user interface. The edge model may escalate captured sounds for cloud analysis when the sounds have ambiguous characteristics that exceed the classification capabilities of the edge model but may be resolvable by the more sophisticated machine learning models running on the server.

In a preferred embodiment, a reinforcement learning or adaptive policy model may adjust sensitivity thresholds, wake intervals, microphone gain, beamforming settings, or transmission rules to balance power consumption against detection performance during extended field deployment. The adaptive policy model may learn optimal operating parameters through trial and error, receiving reward signals based on detection outcomes and power consumption metrics observed during operation. In some preferred embodiments, the adaptive policy model may increase sensitivity thresholds during periods of high background noise to reduce false positive detections that would waste battery power through unnecessary processing and transmission. The adaptive policy model may adjust wake intervals to concentrate active listening during time periods when target wildlife vocalizations are most likely to occur, such as early morning hours for turkey gobbling activity. Alternatively, the adaptive policy model may adjust microphone gain based on ambient noise levels to maintain consistent detection sensitivity across varying environmental conditions. The adaptive policy model may further adjust beamforming settings to focus acoustic sensitivity in directions where wildlife activity has been previously detected, which can improve detection range while reducing sensitivity to noise sources in other directions.

In another preferred embodiment, the system may maintain separate machine learning models for edge inference and cloud inference, with the lighter edge model handling rapid local decisions and the more complex cloud model handling retraining, long-term analysis, and cross-property learning. The edge model may be optimized for computational efficiency to run on the processor of the field unit with limited memory and processing resources, while the cloud model may use larger neural network architectures and more sophisticated algorithms that benefit from the computational resources available on the server. In some instances, the edge model may perform preliminary classification to filter obvious non-target sounds before transmission, while the cloud model may perform refined classification on transmitted sounds to improve species identification accuracy and individual animal recognition. The cloud model may aggregate detection data from multiple field units across the geographic area to perform triangulation, track correlation, and movement pattern analysis that cannot be performed by individual edge models operating in isolation. Alternatively, the cloud model may perform cross-property learning by incorporating detection data from multiple properties to build more robust models that generalize across different habitats, wildlife populations, and environmental conditions. The separation of edge and cloud inference enables the system to balance the competing demands of real-time responsiveness, power efficiency, and analytical sophistication across the distributed architecture of field units and server components.

In some preferred embodiments, the machine learning classification model trained on wildlife vocalizations may classify a species of an animal producing a sound source based on acoustic characteristics of the sound source, as described previously. The machine learning noise reduction model may perform local filtering to reduce at least one of wind noise, rain noise, insect noise, vehicle noise, or background interference before transmitting detection data from the field unit to the server. In some instances, the machine learning pattern recognition model may identify recurring travel routes based on aggregated triangulated positions over a plurality of time periods, enabling the system to generate heat maps, line overlays, or probability zones representing recurring travel routes on a geospatial map. The machine learning similarity model may compare a subsequent detection with an acoustic signature to determine whether the subsequent detection corresponds to an individual animal previously identified by the system. Alternatively, the machine learning multi-target tracking model may maintain separate tracks for different animals based on acoustic signatures when multiple animals are detected within the geographic area simultaneously. The machine learning trajectory prediction model may generate movement information based on a plurality of triangulated positions over time, enabling the system to infer travel paths and predict future wildlife locations based on historical detection patterns and current observations.

In a preferred embodiment, the present disclosure describes triangulation and detection methods wherein the system receives detection data from a plurality of field units positioned at spaced locations across a geographic area, wherein each field unit comprises a microphone array configured to determine an estimated bearing to a sound source, and wherein the detection data includes the estimated bearing, a timestamp, and a geographic position of each field unit. The detection data transmitted by each field unit may include the estimated bearing determined by the processor based on signals received by the plurality of microphones arranged in the known geometry, as described previously. The timestamp associated with each detection enables the server to correlate detections from at least two field units that correspond to a same sound event based on the timestamps, which is a prerequisite for accurate triangulation of wildlife positions. The geographic position of each field unit may be determined by the positioning component such as a GPS receiver module, and the geographic position provides the reference coordinates from which the estimated bearing extends toward the sound source. In some instances, the detection data may further include confidence scores, signal quality indicators, and preliminary species classifications generated by edge processing on the field unit before transmission. The combination of estimated bearings, timestamps, and geographic positions from multiple field units enables the server to perform triangulation operations that determine the geographic position of the sound source with greater precision than a single field unit can achieve independently.

In another preferred embodiment, the field units may communicate through cellular communication paths that leverage existing mobile network infrastructure to transmit detection data to the server. Cellular communication paths can provide reliable connectivity in geographic areas with adequate cellular coverage, enabling real-time or near-real-time transmission of detection data from field units deployed across hunting properties, ranches, and conservation areas. The field units may communicate through Wi-Fi communication paths in deployment scenarios where wireless local area network infrastructure is available, such as properties with existing Wi-Fi coverage extending to outdoor areas where field units are positioned. Alternatively, the field units may communicate through satellite communication paths in remote geographic areas where cellular and Wi-Fi coverage is unavailable, which enables deployment of the distributed acoustic sensing network in wilderness areas, backcountry hunting locations, and isolated conservation sites. The field units may communicate through mesh radio communication paths wherein multiple field units form an interconnected network that relays detection data between units until the data reaches a gateway unit with connectivity to the server. In some preferred embodiments, the field units may communicate through LoRa communication paths that provide long-range, low-power wireless connectivity suitable for battery-operated field units deployed across large geographic areas where other communication options are limited or unavailable.

In some preferred embodiments, the system may operate continuously for constant monitoring of wildlife acoustic activity across the geographic area covered by the distributed network of field units. Continuous operation can capture wildlife vocalizations at any time of day or night, which is beneficial for species that vocalize unpredictably or during periods when the user is not actively monitoring the system. The system may operate on a schedule to conserve power, wherein the field units activate their microphone arrays and processing capabilities during predetermined time windows that correspond to periods of expected wildlife activity. Scheduled operation can extend battery life by reducing power consumption during periods when target wildlife vocalizations are unlikely to occur, such as midday hours for species that vocalize primarily during dawn and dusk. Alternatively, the system may operate in event-driven mode to conserve power, wherein the field units maintain a low-power listening state and transition to full processing mode when acoustic activity exceeding a threshold is detected. Event-driven operation can provide a balance between power conservation and detection coverage by activating full processing capabilities in response to detected sounds while minimizing power consumption during quiet periods.

In a preferred embodiment, the analytics may be performed fully in the cloud on the server, wherein the field units transmit raw audio, compressed audio, or extracted features to the server for classification, triangulation, and movement analysis. Cloud-only analytics can leverage the computational resources available on the server to run sophisticated machine learning models that exceed the processing capabilities of the field units, enabling more accurate species classification, individual animal recognition, and movement prediction. The analytics may be performed fully at the edge on the field units in deployment scenarios where network connectivity is limited, intermittent, or expensive, wherein each field unit performs classification and bearing estimation locally and stores results for later retrieval or batch transmission. Edge-only analytics can reduce bandwidth consumption and enable operation in remote areas without reliable network connectivity, though the triangulation capabilities may be limited without real-time coordination between multiple field units. In some preferred embodiments, the analytics may be performed in a hybrid arrangement where preliminary classification occurs locally on field units and higher-order correlation occurs remotely on the server. The hybrid arrangement can balance the competing demands of real-time responsiveness, bandwidth efficiency, and analytical sophistication by distributing processing tasks between edge and cloud components according to their respective capabilities and resource constraints.

In another preferred embodiment, the server may be configured to correlate detections from at least two field units that correspond to a same sound event by comparing timestamps, estimated bearings, and acoustic characteristics of detections received from the distributed network of field units. The correlation process may identify detections that occurred within a time window consistent with the propagation delay of sound traveling from a common source to multiple field units positioned at different locations across the geographic area. In some instances, the correlation process may further compare spectral characteristics, amplitude profiles, and duration measurements of detected sounds to confirm that detections from different field units correspond to the same vocalization event rather than separate vocalizations occurring in close temporal proximity. The server may triangulate a geographic position of the sound source based on the estimated bearings from the at least two field units and the geographic positions of the at least two field units, wherein the triangulation process determines the intersection point or region where the bearing lines from multiple field units converge. The step of determining the estimated bearing may comprise at least one of time difference of arrival analysis, phase difference analysis, amplitude difference analysis, or beamforming, as described previously. The triangulated geographic position provides the user with location information that indicates where the vocalizing animal was located at the time of the detected sound event.

In some preferred embodiments, the system may generate a probabilistic location surface rather than a single point for animal location, wherein the probabilistic location surface represents the uncertainty in the triangulated position based on the quality of the detection data and the geometry of the detecting field units. The probabilistic location surface can assign probability values to different geographic coordinates within a region surrounding the most likely location, which communicates the confidence level of the location estimate to the user through the user interface. The machine learning model may rank or weight candidate triangulations by confidence so that lower-quality detections do not distort the resulting track when multiple detections are combined to infer movement patterns over time. Confidence weighting can reduce the influence of detections with poor signal quality, ambiguous bearing estimates, or unfavorable field unit geometry on the overall movement track generated by the system. In some instances, the confidence weighting may consider factors such as signal-to-noise ratio, bearing estimation uncertainty, number of detecting field units, and geometric dilution of precision when assigning weights to candidate triangulations. The probabilistic approach enables the system to generate movement information based on a plurality of triangulated positions over time while appropriately accounting for the varying reliability of individual detection events.

In a preferred embodiment, the system may cluster sound events by time, direction, location, spectral signature, and other features to estimate likely movement paths when individual calls cannot be matched with complete certainty. Sound event clustering can group detections that share similar acoustic characteristics and spatial-temporal relationships, enabling the system to infer that clustered detections likely originated from the same animal or group of animals moving through the geographic area. The clustering process may consider the time intervals between detections, the consistency of movement direction implied by sequential detections, the geographic proximity of triangulated positions, and the similarity of spectral features extracted from the detected vocalizations. In some instances, the clustering process may generate multiple candidate movement paths with associated probability scores when the detection data is consistent with more than one interpretation of animal movement. Alternatively, the clustering process may merge detections into a single track when the evidence strongly supports a common source, or the clustering process may maintain separate tracks when the evidence suggests multiple animals vocalizing in the same general area. The sound event clustering capabilities enable the system to generate meaningful movement information even when detection conditions are imperfect or when multiple animals are active simultaneously within the monitored geographic area.

In another preferred embodiment, the system may identify common travel routes including roost-to-feeding routes, bedding-to-water routes, crossing points, corridors, strut zones, and calling stations based on aggregated triangulated positions over a plurality of time periods. Roost-to-feeding route identification can reveal the paths that turkeys and other roosting birds follow when departing roost trees in the morning and traveling to feeding areas, which can inform hunting setup locations and timing decisions. Bedding-to-water route identification can reveal the paths that deer, elk, and other ungulates follow when traveling between bedding areas and water sources, which can inform stand placement and observation strategies. In some preferred embodiments, crossing point identification can reveal locations where wildlife repeatedly crosses terrain features such as fences, roads, streams, or ridgelines, which can indicate high-traffic areas suitable for hunting or observation. Corridor identification can reveal linear travel routes that wildlife follows along terrain features such as drainages, field edges, timber boundaries, or ridgelines that channel movement through predictable paths. Strut zone identification can reveal areas where male turkeys repeatedly display and vocalize during breeding season, which can inform decoy placement and calling strategies. Calling station identification can reveal locations where wildlife repeatedly vocalizes, which can indicate territorial boundaries, social gathering areas, or preferred habitat features that attract recurring wildlife activity within the monitored geographic area.

In a preferred embodiment, the present disclosure describes a user interface through which users access the wildlife detection and localization system to view detection data, triangulated positions, movement information, and historical patterns generated by the distributed network of field units and server components. The user interface may be provided through a mobile phone application that enables users to access system functionality from smartphones while in the field, at home, or at other locations where mobile network connectivity is available. The mobile phone application can present detection alerts, geospatial maps, and analysis results on the display of the smartphone, allowing users to monitor wildlife activity without requiring access to desktop computing equipment. In some instances, the mobile phone application may be configured to operate in offline mode when network connectivity is temporarily unavailable, caching previously downloaded detection data and map layers for continued viewing until connectivity is restored. The mobile phone application may synchronize with the server when connectivity becomes available to upload user annotations, download new detections, and refresh map displays with current information. Alternatively, the user interface may be provided through a tablet application that offers a larger display area for viewing geospatial maps and detection visualizations compared to smartphone displays.

In another preferred embodiment, the user interface may be provided through a web interface accessible via standard web browsers on desktop computers, laptop computers, and other computing devices with internet connectivity. The web interface can provide access to the same detection data, triangulated positions, and movement analysis results available through the mobile phone application and tablet application, enabling users to select the interface type that best suits their current computing environment and preferences. In some preferred embodiments, the web interface may offer expanded visualization capabilities that leverage the larger display area and processing resources available on desktop computing systems compared to mobile devices. The web interface may present detailed statistical summaries, multi-property comparisons, and extended historical analyses that benefit from the screen real estate available on desktop monitors. The tablet application may provide an intermediate option between the mobile phone application and web interface, offering portability similar to the mobile phone application while providing a larger display area that can accommodate more detailed map views and detection lists. The multiple interface types enable users to access the wildlife detection and localization system through whichever client device is most convenient for their current situation and analysis needs.

In a preferred embodiment, the user interface may allow the user to select a time range to filter the information shown on the geospatial map and in detection lists presented through the mobile phone application, tablet application, or web interface. Time range filtering can enable users to focus on detections from specific periods such as the current day, the past week, a particular hunting season, or a custom date range defined by the user. In some instances, the time range filter may be combined with time-of-day filtering to show detections from specific hours across multiple days, such as early morning detections that may indicate roost departure patterns or evening detections that may indicate return-to-roost movements. The user interface may allow the user to select a species to filter the information shown, enabling users who are interested in a particular target species to exclude detections of other species from the display. Species filtering can be beneficial when the distributed network of field units detects multiple species within the monitored geographic area and the user wishes to focus analysis on a single species such as turkeys, coyotes, or elk. The species filter may present a list of species that have been detected within the selected time range, allowing users to select one or more species for inclusion in the filtered display.

In some preferred embodiments, the user interface may allow the user to select an individual animal signature to filter the information shown, enabling users to track the movements and vocalization patterns of specific animals that have been identified through the acoustic signature recognition capabilities of the system. Individual animal signature filtering can display detections attributed to a particular gobbler, coyote, or other vocalizing animal while excluding detections from other individuals of the same species, which enables focused analysis of individual animal behavior over time. The user interface may allow the user to select a confidence threshold to filter the information shown, enabling users to exclude low-confidence detections that may represent uncertain classifications or ambiguous bearing estimates from the display. Confidence threshold filtering can improve the clarity of map displays by removing detections that do not meet a user-specified reliability standard, which can be adjusted based on the user's tolerance for uncertainty in the displayed information. In some instances, users may set a high confidence threshold when making decisions based on detection data, while setting a lower confidence threshold when exploring the full range of acoustic activity captured by the field units. The confidence threshold filter may be applied independently or in combination with time range, species, and individual animal signature filters to create customized views of the detection data.

In another preferred embodiment, the user interface may allow the user to select a property boundary to filter the information shown, enabling users who manage multiple properties or who share access to detection data from neighboring properties to focus on detections within a specific geographic area. Property boundary filtering can display detections that fall within the selected property while excluding detections from adjacent properties or from areas outside the user's area of interest. The property boundary filter may be configured using property boundary data uploaded by the user, imported from geographic information system files, or drawn manually on the geospatial map through the user interface. In some preferred embodiments, the property boundary filter may work in conjunction with permission levels that control which users can view detection data from which properties, as described in greater detail below. The combination of time range, species, individual animal signature, confidence threshold, and property boundary filters enables users to create highly customized views of the detection data that focus on the specific information relevant to their current analysis objectives. The filtering capabilities can reduce information overload when large volumes of detection data have accumulated over extended deployment periods.

In a preferred embodiment, the user interface may provide near real-time alerts indicating that a target sound has been detected along with a direction or mapped location, enabling users to receive timely notification of wildlife activity within the monitored geographic area. Near real-time alerts can be delivered through push notifications on mobile devices, email messages, text messages, or in-application notifications depending on user preferences and notification settings configured through the user interface. The alerts may include information such as the species classification, confidence score, estimated bearing, triangulated position, and timestamp associated with the detected sound event. In some instances, the alerts may include a link or button that opens the user interface directly to a map view centered on the detection location, enabling rapid assessment of the detection context. The near real-time alert functionality can support hunting applications where timely awareness of wildlife vocalizations may inform decisions about movement, positioning, or calling strategies. Alternatively, the near real-time alerts may support wildlife research and conservation applications where researchers wish to be notified when target species vocalize within study areas.

In some preferred embodiments, the user interface may provide playback of stored detections, enabling users to listen to audio recordings of detected wildlife vocalizations captured by the field units and transmitted to the server for storage. Detection playback can enable users to verify species classifications, assess call quality, compare vocalizations between different detections, and develop familiarity with the acoustic characteristics of wildlife within the monitored geographic area. The playback functionality may include controls for adjusting playback volume, playback speed, and audio filtering to enhance the audibility of wildlife sounds relative to background noise. In some instances, the playback functionality may display spectrograms or waveform visualizations alongside the audio playback to provide visual representation of the acoustic characteristics of the detected sound. The stored detections available for playback may be filtered using the same time range, species, individual animal signature, confidence threshold, and property boundary filters described previously. The playback functionality enables users to engage with the raw acoustic data underlying the detection events, classifications, and triangulated positions presented through the user interface.

In a preferred embodiment, the user interface may integrate property maps, topographic layers, satellite imagery, trail data, stand locations, blind locations, roads, fences, food plots, and water features to provide contextual information that supports interpretation of detection data and movement patterns. Property maps can display property boundaries, parcel lines, and ownership information that helps users understand the geographic extent of the monitored area and the relationship between detection locations and property features. Topographic layers can display elevation contours, slope gradients, and terrain features such as ridgelines, valleys, and drainages that may influence wildlife movement patterns and acoustic propagation characteristics. Satellite imagery can provide visual context showing vegetation cover, land use patterns, and landscape features that may not be apparent from topographic data alone. In some instances, the satellite imagery may be updated periodically to reflect seasonal changes in vegetation, crop conditions, and land cover that may affect wildlife habitat and movement patterns. The integration of multiple map layers enables users to view detection data in the context of the physical landscape where wildlife activity occurs.

In another preferred embodiment, the user interface may integrate trail data showing hiking trails, game trails, and access routes that may be relevant to wildlife movement patterns and user access to the monitored geographic area. Stand locations can be displayed on the geospatial map to show the positions of hunting stands, observation platforms, and other elevated positions where users may position themselves for hunting or wildlife observation. Blind locations can be displayed to show the positions of ground blinds, pit blinds, and other concealed positions that users may use for hunting or photography within the monitored area. Roads can be displayed to show vehicle access routes, property access points, and road crossings that may influence wildlife movement patterns or provide reference points for navigation within the property. In some preferred embodiments, fences can be displayed to show fence lines, gates, and fence crossings that may channel wildlife movement along predictable corridors or create barriers that influence travel routes. Food plots can be displayed to show the locations of planted food sources that may attract wildlife and concentrate activity in specific areas within the monitored geographic area. Water features can be displayed to show streams, ponds, springs, and other water sources that may attract wildlife and influence movement patterns between water sources and other habitat features.

In some preferred embodiments, the server may support multiple users with different permission levels, enabling property owners, hunting guides, researchers, and other authorized users to access detection data with appropriate access controls based on their roles and relationships to the monitored properties. Permission levels can control which users can view detection data, which users can modify system settings, which users can add or remove field units, and which users can grant access to other users. The permission level structure can support scenarios where a property owner grants limited access to hunting clients, where a research organization grants access to collaborating researchers, or where a hunting outfitter grants access to guides who need to monitor wildlife activity on behalf of clients. In some instances, permission levels may control access to specific data types, such as allowing some users to view species-level detection summaries while restricting access to individual animal signatures or raw audio recordings. The multi-user support enables the wildlife detection and localization system to serve organizations and groups where multiple individuals need access to shared detection data with appropriate access controls. The server may maintain audit logs recording user access and modifications to support accountability and troubleshooting within multi-user deployments.

In a preferred embodiment, the server may support multiple properties for a single user or organization, enabling users who manage wildlife on multiple ranches, hunting leases, or conservation areas to access detection data from different geographic areas through a unified user interface. Multi-property support can enable users to switch between properties within the mobile phone application, tablet application, or web interface to view detection data, triangulated positions, and movement patterns specific to each property. The server may maintain separate databases or data partitions for each property to organize detection data, field unit configurations, and user permissions on a per-property basis. In some preferred embodiments, the multi-property support may enable cross-property analysis for users who wish to compare wildlife activity patterns between different properties or aggregate detection data across multiple properties for regional analysis. The property boundary filter described previously can work in conjunction with multi-property support to enable users to focus on specific properties within their portfolio of monitored areas. The multi-property architecture enables the system to scale from single-property deployments to enterprise deployments spanning numerous properties across diverse geographic regions.

In another preferred embodiment, the server may support long-term storage for seasonal analysis of wildlife data, enabling users to retain detection data, triangulated positions, and movement patterns across multiple seasons and years for trend analysis and historical comparison. Long-term storage can preserve detection data beyond the immediate operational period, enabling users to compare current wildlife activity with activity from previous seasons, identify year-over-year changes in movement patterns, and assess the effects of habitat management activities on wildlife populations over time. The server may organize long-term storage by property, season, species, and other attributes to facilitate retrieval and analysis of historical data through the user interface. In some instances, the long-term storage may include archived audio recordings, detection metadata, triangulated positions, inferred travel paths, and environmental data associated with each detection event. The seasonal analysis capabilities enabled by long-term storage can support wildlife management decisions, hunting strategy development, and research objectives that benefit from multi-year datasets. The server may implement data retention policies that balance storage costs against the analytical value of historical data, optionally allowing users to configure retention periods based on their specific needs.

In some preferred embodiments, the system may provide comparisons between present and historical movement patterns in the user interface, enabling users to assess whether current wildlife activity is consistent with patterns observed during previous time periods. Present and historical movement pattern comparisons can display current detections alongside historical heat maps, line overlays, or probability zones representing recurring travel routes on a geospatial map, as described previously. The comparison functionality can highlight areas where current activity differs from historical patterns, which may indicate changes in wildlife behavior, habitat conditions, or population dynamics within the monitored geographic area. In some instances, the comparison functionality may enable users to select specific historical time periods for comparison, such as the same week in the previous year or the same phase of the hunting season in previous years. The historical pattern comparisons can inform hunting strategy by revealing whether wildlife is using expected routes or has shifted to alternative travel corridors. Presenting, via a user interface, a geospatial map displaying triangulated geographic positions and movement information enables users to visualize both current detections and historical patterns in a unified spatial context that supports informed decision-making.

In a preferred embodiment, the system may provide annotations and environmental data in the user interface, enabling users to add notes, observations, and contextual information to detection events and to view environmental conditions associated with detection times. Annotations can include user-entered text describing observations made during field visits, outcomes of hunting activities, visual sightings that confirm or supplement acoustic detections, and other information that adds context to the detection data. The annotation functionality may enable users to attach annotations to specific detection events, specific locations on the geospatial map, or specific time periods within the detection history. In some preferred embodiments, environmental data may be displayed alongside detection data to show weather conditions, temperature, barometric pressure, wind speed, wind direction, and other environmental variables that may influence wildlife vocalization patterns and movement behavior. The environmental data may be obtained from weather services, on-site weather stations, or sensors integrated with the field units deployed across the monitored geographic area. The combination of user annotations and environmental data enriches the detection information available through the user interface and supports more comprehensive analysis of wildlife activity patterns within the monitored geographic area.

As illustrated in FIG. 7, the present disclosure describes a method 700 for identifying wildlife via acoustic signals obtained by the microphones 508 of the field units 406. The method 700 begins at step 705, wherein the system 400 may be configured to initialize one or more field units 406 positioned at spaced locations across a geographic area. In a preferred embodiment, each field unit 406 may establish communication with the server 110 and synchronize its internal clock with other field units 406 in the network to enable coordinated detection. The initialization process can include calibration of the microphone array, verification of GPS positioning, and confirmation of wireless connectivity. In some instances, the field units 406 may perform self-diagnostic routines to verify proper operation of acoustic sensing components before commencing active monitoring. Alternatively, the initialization may be triggered remotely by a user 405 through the user interface 411 of the mobile computing device 410.

In step 710, the method 700 may proceed to continuous acoustic monitoring, wherein the microphones 508 of each field unit 406 capture ambient sounds from the surrounding environment. In some preferred embodiments, the microphone array may be configured to sample audio at rates sufficient to capture the frequency range of target wildlife vocalizations, such as turkey gobbles, elk bugles, or deer vocalizations. The captured acoustic data can be temporarily stored in the memory 304 of the field unit 406 for subsequent processing. In another preferred embodiment, the field unit 406 may employ noise filtering algorithms to reduce interference from wind, rain, insects, or anthropogenic sources such as vehicles or machinery. The acoustic monitoring may operate continuously during designated time periods or may be triggered by amplitude thresholds that indicate potential wildlife activity. For instance, a field unit 406 deployed in a turkey hunting area may be configured to activate detailed recording when sound levels exceed a baseline threshold indicative of a gobble.

At step 715, the processor 220 of each field unit 406 may analyze the captured acoustic signals to detect potential wildlife vocalizations. In a preferred embodiment, the analysis may employ machine learning classification models trained on datasets of wildlife vocalizations to distinguish target species sounds from background noise and non-target acoustic events. The classification model can evaluate acoustic features such as frequency content, temporal patterns, harmonic structure, and amplitude envelope to determine whether a detected sound corresponds to a wildlife species of interest. In some instances, the processor 220 may assign a confidence score to each detection, indicating the likelihood that the sound originated from a target species. For instance, a detected sound exhibiting frequency characteristics and cadence consistent with a wild turkey gobble may receive a high confidence score, while an ambiguous sound may receive a lower score. Alternatively, the field unit 406 may transmit raw or minimally processed acoustic data to the server 110 for centralized classification when local processing resources are limited.

In step 720, the method 700 may proceed to bearing estimation, wherein the processor 220 determines the direction from which the detected wildlife vocalization originated. In some preferred embodiments, the bearing estimation may utilize time difference of arrival analysis, wherein the processor 220 calculates the slight temporal offset between when a sound wave reaches different microphones 508 in the array. The known geometry of the microphone array enables the processor 220 to compute an estimated bearing angle relative to the field unit 406 orientation. Alternatively, the bearing estimation may employ phase difference analysis, amplitude difference analysis, or beamforming techniques depending on the configuration of the microphone array and the characteristics of the detected sound. In another preferred embodiment, the processor 220 may generate multiple bearing estimates for a single vocalization event and compute a weighted average to improve accuracy. For instance, a turkey gobble lasting several seconds may yield multiple bearing samples that can be averaged to reduce the influence of momentary acoustic reflections or interference.

At step 725, the field unit 406 may transmit detection data to the server 110 via the wireless communication interface 280. The detection data can include the estimated bearing, a timestamp synchronized across the network of field units 406, the geographic position of the field unit 406 as determined by the GPS receiver module 370, and optionally acoustic features or audio samples associated with the detection. In a preferred embodiment, the transmission may occur in near real-time to enable prompt triangulation and user notification. In some instances, the field unit 406 may buffer multiple detections and transmit them in batches to conserve power and bandwidth when operating in areas with limited cellular coverage. The server 110 may receive detection data from multiple field units 406 that detected the same vocalization event, enabling subsequent correlation and triangulation. For instance, a loud elk bugle may be detected by three field units 406 positioned at different locations around a meadow, with each field unit 406 transmitting its bearing estimate and timestamp to the server 110.

In step 730, the server 110 may correlate detections from multiple field units 406 to identify those corresponding to the same sound event. In some preferred embodiments, the correlation process may compare timestamps to identify detections occurring within a time window consistent with sound propagation across the geographic area covered by the field units 406. The server 110 can evaluate the consistency of bearing estimates to confirm that multiple detections plausibly originated from a common sound source. In another preferred embodiment, the server 110 may employ acoustic fingerprinting techniques to match detections based on spectral characteristics, ensuring that correlated detections correspond to the same vocalization rather than separate vocalizations occurring in close temporal proximity. For instance, two turkey gobbles occurring within seconds of each other from different locations may be distinguished based on subtle differences in frequency content or duration. Alternatively, machine learning models may be configured to perform correlation by learning patterns in detection data that indicate common versus distinct sound sources.

At step 735, the method 700 may proceed to triangulation, wherein the server 110 computes the geographic position of the sound source based on the correlated detections. In a preferred embodiment, the triangulation may utilize the estimated bearings from at least two field units 406 along with the known geographic positions of those field units 406 to calculate the intersection point representing the sound source location. The server 110 can employ geometric algorithms that account for bearing uncertainty to generate a position estimate along with an associated confidence region. In some instances, detections from three or more field units 406 may enable more precise triangulation and provide redundancy that improves reliability. For instance, when four field units 406 detect a deer vocalization, the server 110 may compute multiple intersection points and apply statistical methods to determine the most probable source location. Alternatively, the server 110 may employ optimization algorithms that minimize the aggregate error across bearing estimates when computing the triangulated position.

In step 740, the server 110 may generate movement information based on a plurality of triangulated positions over time. In some preferred embodiments, the server 110 may track sequential vocalizations from the same animal to infer travel direction, speed, and path. The server 110 can employ machine learning trajectory prediction models to estimate likely future positions based on observed movement patterns and terrain features. In another preferred embodiment, the server 110 may correlate acoustic signatures across detections to associate multiple vocalizations with the same individual animal, enabling tracking of specific animals over extended time periods. For instance, a bull elk with a distinctive bugle pattern may be tracked across multiple days as it moves through a hunting unit, with the server 110 maintaining a record of triangulated positions associated with that individual. Alternatively, the server 110 may aggregate movement data from multiple animals to identify recurring travel routes, bedding areas, or feeding locations within the geographic area.

At step 745, the method 700 may present the triangulated positions and movement information to the user 405 via a geographic information system displayed on the user interface 411. In a preferred embodiment, the user interface 411 may overlay triangulated wildlife positions on a geospatial map showing terrain features, vegetation, water sources, property boundaries, and other relevant geographic data. The user 405 can view current wildlife locations as well as historical detection data and inferred travel paths. In some instances, the user interface 411 may display heat maps indicating areas of concentrated wildlife activity or probability zones representing likely current positions based on recent detections and movement predictions. For instance, a hunter using the mobile computing device 410 may view a map showing the triangulated position of a gobbling turkey along with an arrow indicating the direction of travel inferred from sequential detections. Alternatively, the user interface 411 may provide alerts or notifications when wildlife is detected within a user-defined area of interest. The method 700 concludes at step 750, wherein the system 400 may continue monitoring for additional wildlife vocalizations or may enter a standby mode until reactivated by the user 405 or by detection of acoustic activity exceeding configured thresholds.

As illustrated in FIG. 8, the present disclosure describes a method 800 for identifying wildlife travel paths through a geographic area covered by the field units 406. The method 800 begins at step 805, wherein the system 400 may be configured to aggregate triangulated wildlife position data collected over an extended time period from the database 115. In a preferred embodiment, the aggregated data may include timestamps, species classifications, geographic coordinates, and acoustic signatures associated with each detection event. The processor 220 can retrieve wildlife data 435B and path data 435C stored within the user profile 435 to compile a comprehensive dataset for path analysis. In some instances, the system 400 may filter the aggregated data based on user-specified parameters such as date ranges, species types, or geographic boundaries. For instance, a land manager may configure the system 400 to analyze path data 435C collected during the autumn months to understand deer movement patterns during the rut season.

In step 810, the method 800 may proceed to spatial clustering analysis, wherein the server 110 identifies geographic regions exhibiting concentrated wildlife activity. In some preferred embodiments, the server 110 may employ machine learning clustering algorithms to group triangulated positions that fall within proximity thresholds indicative of common travel corridors or congregation areas. The clustering analysis can reveal natural funnels, crossing points, or staging areas where wildlife activity concentrates due to terrain features, vegetation patterns, or resource availability. In another preferred embodiment, the processor 220 may weight recent detections more heavily than older detections to account for seasonal shifts in wildlife behavior. Alternatively, the system 400 may perform separate clustering analyses for different time periods to identify temporal variations in path usage. For instance, the server 110 may identify that whitetail deer concentrate near a particular creek crossing during morning hours while utilizing a different corridor during evening movement periods.

At step 815, the method 800 may analyze sequential detection events to reconstruct individual travel paths through the geographic area. In a preferred embodiment, the server 110 may connect temporally adjacent triangulated positions associated with the same animal to form path segments representing observed movement trajectories. The processor 220 can employ machine learning trajectory reconstruction models that interpolate likely routes between detection points based on terrain data, vegetation cover, and known wildlife movement behaviors. In some instances, the system 400 may utilize acoustic signature matching to associate detections with specific individual animals, enabling reconstruction of paths taken by identified animals over multiple days or weeks. The path reconstruction process may account for gaps in detection coverage by inferring probable routes through areas lacking field unit 406 coverage. For instance, when tracking a specific bull elk identified by its distinctive bugle pattern, the server 110 may reconstruct a multi-day travel path showing the animal's movement between feeding meadows and bedding areas within a mountain drainage.

In step 820, the method 800 may proceed to species-specific path preference analysis, wherein the server 110 identifies travel routes favored by particular wildlife species. In some preferred embodiments, the processor 220 may aggregate path data 435C across multiple animals of the same species to identify corridors exhibiting statistically significant usage patterns. The analysis can reveal that certain species preferentially utilize specific terrain features, vegetation types, or landscape corridors when moving through the geographic area. In another preferred embodiment, the system 400 may compare path preferences across different species to identify shared corridors or species-specific route selections. Alternatively, the server 110 may correlate path preferences with environmental data 435D such as weather conditions, moon phase, or barometric pressure to identify factors influencing route selection. For instance, the system 400 may determine that wild turkeys consistently travel along a particular ridgeline when moving between roosting and feeding areas, while coyotes preferentially utilize a parallel drainage bottom.

At step 825, the method 800 may generate predictive models for wildlife movement timing based on historical path data 435C. In a preferred embodiment, the server 110 may employ machine learning temporal prediction models trained on aggregated detection data to forecast when animals are likely to traverse identified travel corridors. The predictive models can incorporate variables such as time of day, day of week, season, weather conditions, and lunar cycle to estimate probability distributions for wildlife presence along specific paths. In some instances, the processor 220 may generate predictions for individual animals based on their observed movement patterns and behavioral tendencies. The system 400 may optionally refine predictions as additional detection data becomes available, improving forecast accuracy over time through continuous learning. For instance, the server 110 may predict that a group of turkeys is likely to travel through a particular saddle between 6:30 and 7:15 AM on mornings following clear nights, based on patterns observed across the previous hunting season.

In step 830, the method 800 may present the identified paths and predictive information to the user 405 via the user interface 411 of the mobile computing device 410. In some preferred embodiments, the user interface 411 may display identified travel corridors as line overlays on a geospatial map, with line thickness or color intensity indicating relative usage frequency. The user 405 can view species-specific path layers, temporal usage patterns, and predicted movement windows for identified corridors. In another preferred embodiment, the user interface 411 may provide interactive filtering controls allowing the user 405 to display paths meeting specified criteria such as species, time period, or confidence level. Alternatively, the system 400 may generate automated reports summarizing path analysis findings and movement predictions for user review. For instance, a hunter preparing for an upcoming hunt may view a map displaying high-probability turkey travel corridors along with predicted timing windows, enabling strategic positioning based on historical movement patterns.

At step 835, the method 800 may update the path database with newly identified routes and refined predictions based on ongoing detection activity. In a preferred embodiment, the server 110 may continuously incorporate new triangulated positions into the path analysis framework, allowing identified corridors and predictions to evolve as additional data accumulates. The processor 220 can employ machine learning model updating techniques that balance retention of historical patterns with adaptation to recent behavioral changes. In some instances, the system 400 may detect shifts in path usage that indicate changes in wildlife behavior due to hunting pressure, habitat modification, or seasonal transitions. The path data 435C stored within the database 115 may be configured to maintain versioned records enabling comparison of path usage across different time periods. The method 800 concludes at step 840, wherein the system 400 may continue path analysis operations or may archive the current analysis results for future reference. For instance, the system 400 may detect that deer have shifted their travel corridor away from an area experiencing increased human activity and update the path predictions accordingly.

To prevent un-authorized users from accessing other user's information, the system 400 may employ a security method. As illustrated in FIG. 9, the security method of the system 400 may comprise a plurality of permission levels 900 that may grant users 405 access to user content 915, 935, 955 within the database while simultaneously denying users 405 without appropriate permission levels 900 the ability to view user content 915, 935, 955. To access the user content 915, 935, 955 stored within the database 115, users 405 may be required to make a request via a user interface 411. Access to the data within the database 115 may be granted or denied by the processor 220 based on verification of a requesting user's 905, 925, 945 permission level 900. If the requesting user's 905, 925, 945 permission level 900 is sufficient, the processor 220 may provide the requesting user 905, 925, 945 access to user content 915, 935, 955 stored within the database. Conversely, if the requesting user's 905, 925, 945 permission level 900 is insufficient, the processor 220 may deny the requesting user 905, 925, 945 access to user content 915, 935, 955 stored within the database. In an embodiment, permission levels 900 may be based on user roles 910, 930, 950 and administrator roles 970, as illustrated in FIG. 9. User roles 910, 930, 950 allow requesting users 905, 925, 945 to access user content 915, 935, 955 that a user 405 has uploaded and/or otherwise obtained through use of the system 400. Administrator roles 970 allow administrators 965 to access system 400 wide data.

In an embodiment, user roles 910, 930, 950 may be assigned to a user 405 in a way such that a requesting user 905, 925, 945 may view user profiles 430 containing user data 453A, wildlife data 435B, path data 435C, and environmental data 435D via a user interface 411. To access the data within the database 115, a user 405 may make a user request via the user interface 411 to the processor 220. In an embodiment, the processor 220 may grant or deny the request based on the permission level 900 associated with the requesting user 905, 925, 945. Only users 405 having appropriate user roles 910, 930, 950 or administrator roles 970 may access the data within the user profiles 430. For instance, as illustrated in FIG. 9, requesting user 1 905 has permission to view user 1 content 915 and user 2 content 935 whereas requesting user 2 925 only has permission to view user 2 content 935. Alternatively, user content 915, 935, 955 may be restricted in a way such that a user may only view a limited amount of user content 915, 935, 955. For instance, requesting user 3 945 may be granted a permission level 900 that only allows them to view user 3 content 955 related to their specific interest but not user 3 content 955 related to the identity of said user 405. In the example illustrated in FIG. 9, an administrator 965 may bestow a new permission level 900 on users 405 so that it may grant them greater permissions or lesser permissions. For instance, an administrator 965 may bestow a greater permission level 900 on other users 405 so that they may view user 3's content 955 and/or any other user's content 915, 935, 955. Therefore, the permission levels 900 of the system 400 may be assigned to users 405 in various ways without departing from the inventive subject matter described herein.

A number of implementations have been described. Nevertheless, it will be understood that various modifications may be made without departing from the spirit and scope of the disclosure. Accordingly, other implementations are within the scope of the following claims.

1. A wildlife detection and localization system, comprising:
a plurality of field units positioned at spaced locations across a geographic area, wherein each field unit of said plurality of field units comprises:
a microphone array having a plurality of microphones arranged in a known geometry;
a processor configured to determine an estimated bearing to a sound source based on signals received by said plurality of microphones;
a positioning component configured to determine a geographic position of said field unit;
a wireless communication interface configured to transmit detection data; and
a server operably connected to said plurality of field units via said wireless communication modules, and
a non-transitory computer-readable medium coupled to said processor,
wherein said non-transitory computer-readable medium contains instructions stored thereon, which, when executed by said processor, cause said processor to perform operations comprising:
receiving detection data from said plurality of field units, wherein said detection data includes estimated bearings and timestamps;
correlating detections from at least two field units that correspond to a same sound event;
triangulating a geographic position of said sound source based on said estimated bearings from said at least two field units and said geographic positions of said at least two field units; and
generating movement information based on a plurality of triangulated positions over time.

2. The wildlife detection and localization system of claim 1, wherein said processor is configured to determine said estimated bearing based on at least one of time difference of arrival, phase difference, amplitude difference, or beamforming.

3. The wildlife detection and localization system of claim 1, wherein each field unit further comprises a synchronized clock configured to timestamp detections, wherein said timestamps enable said central server to match detections from said plurality of field units.

4. The wildlife detection and localization system of claim 1, wherein said central server is further configured to classify a species of an animal producing said sound source based on acoustic characteristics of said sound source using a machine learning classification model trained on wildlife vocalizations.

5. The wildlife detection and localization system of claim 4, wherein said central server is further configured to generate an acoustic signature associated with an individual animal using a machine learning feature extraction model based on at least one of frequency content, cadence, harmonic structure, temporal spacing, call length, or amplitude envelope.

6. The wildlife detection and localization system of claim 5, wherein said central server is further configured to compare a subsequent detection with said acoustic signature using a machine learning similarity model to determine whether said subsequent detection corresponds to said individual animal.

7. The wildlife detection and localization system of claim 1, wherein said central server is further configured to identify recurring travel routes based on aggregated triangulated positions over a plurality of time periods using a machine learning pattern recognition model.

8. The wildlife detection and localization system of claim 7, wherein said central server is further configured to generate at least one of a heat map, a line overlay, or a probability zone representing said recurring travel routes on a geospatial map.

9. The wildlife detection and localization system of claim 1, wherein said processor of each field unit is further configured to perform local filtering using a machine learning noise reduction model to reduce at least one of wind noise, rain noise, insect noise, vehicle noise, or background interference before transmitting said detection data.

10. The wildlife detection and localization system of claim 1, wherein at least one field unit further comprises a sound emitter configured to produce sounds into an environment, wherein said sounds include at least one of wildlife vocalizations, calibration signals, or test tones.

11. The wildlife detection and localization system of claim 10, wherein said sound emitter is controllable remotely through a user interface operably connected to said central server.

12. A method for detecting and localizing wildlife using distributed acoustic sensing, comprising steps of:
receiving, by a plurality of field units positioned at spaced locations across a geographic area, acoustic signals from a sound source, wherein each field unit comprises a microphone array having a plurality of microphones arranged in a known geometry;
determining, by a processor of each field unit, an estimated bearing to said sound source based on said acoustic signals received by said plurality of microphones;
transmitting, by each field unit, detection data including said estimated bearing and a timestamp to a central server;
correlating, by said central server, detections from at least two field units that correspond to a same sound event;
triangulating, by said central server, a geographic position of said sound source based on said estimated bearings from said at least two field units and geographic positions of said at least two field units;
classifying, by said central server using a machine learning classification model, said sound source as a target wildlife species; and
inferring, by said central server, a travel path based on a plurality of triangulated positions of said sound source over time.

13. The method of claim 12, wherein said step of determining said estimated bearing comprises at least one of time difference of arrival analysis, phase difference analysis, amplitude difference analysis, or beamforming.

14. The method of claim 12, further comprising a step of:
training said machine learning classification model on a dataset of wildlife vocalizations comprising a plurality of species-specific acoustic samples.

15. The method of claim 12, further comprising steps of:
generating, by said central server using a machine learning feature extraction model, an acoustic signature associated with an individual animal based on at least one of frequency content, cadence, harmonic structure, temporal spacing, call length, or amplitude envelope; and
comparing, using a machine learning similarity model, a subsequent detection with said acoustic signature to determine whether said subsequent detection corresponds to said individual animal.

16. The method of claim 12, further comprising a step of:
generating, by said central server using a machine learning pattern recognition model, at least one of a heat map, a line overlay, or a probability zone representing recurring travel routes on a geospatial map based on aggregated triangulated positions over a plurality of time periods.

17. A non-transitory computer-readable medium containing instructions for wildlife detection and localization, comprising:
a non-transitory computer-readable medium coupled to a processor, wherein said non-transitory computer-readable medium contains instructions stored thereon, which, when executed by said processor, cause said processor to perform operations comprising:
receiving detection data from a plurality of field units positioned at spaced locations across a geographic area, wherein each field unit comprises a microphone array configured to determine an estimated bearing to a sound source, and wherein said detection data includes said estimated bearing, a timestamp, and a geographic position of each field unit;
correlating detections from at least two field units that correspond to a same sound event based on said timestamps;
triangulating a geographic position of said sound source based on said estimated bearings from said at least two field units and said geographic positions of said at least two field units;
classifying said sound source as a target wildlife species using a machine learning classification model trained on a dataset of wildlife vocalizations;
generating movement information based on a plurality of triangulated positions over time using a machine learning trajectory prediction model; and
presenting, via a user interface, a geospatial map displaying said triangulated geographic positions and said movement information.

18. The non-transitory computer-readable medium of claim 17, further comprising additional instructions, which, when executed by said processor, cause said processor to perform additional operations comprising:
generating an acoustic signature associated with an individual animal using a machine learning feature extraction model based on at least one of frequency content, cadence, harmonic structure, temporal spacing, call length, or amplitude envelope; and
comparing a subsequent detection with said acoustic signature using a machine learning similarity model to determine whether said subsequent detection corresponds to said individual animal.

19. The non-transitory computer-readable medium of claim 18, further comprising additional instructions, which, when executed by said processor, cause said processor to perform additional operations comprising:
maintaining separate tracks for different animals based on said acoustic signatures when multiple animals are detected within said geographic area using a machine learning multi-target tracking model.

20. The non-transitory computer-readable medium of claim 17, further comprising additional instructions, which, when executed by said processor, cause said processor to perform additional operations comprising:
generating at least one of a heat map, a line overlay, or a probability zone representing recurring travel routes on said geospatial map based on aggregated triangulated positions over a plurality of time periods using a machine learning pattern recognition model.
